(19) United States
(12) Patent Application Publication
(10) Pub. No.: US 2004/0064450 A1
(43) Pub. Date: Apr. 1, 2004

(54) Method for preparing data to be analyzed, data analysis method, data analysis device, data preparation program, data analysis program, data prediction device, data prediction method, data prediction program and computer

(75) Inventors: Hisaaki Hatano, Kanagawa-Ken (JP); Akihiko Nakase, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/653,292

(22) Filed: Sep. 3, 2003

(30) Foreign Application Priority Data
Sep. 30, 2002 (JP) 2002-287036
Sep. 30, 2002 (JP) 2002-287426

(51) Int. Cl. G06F 17/00; G06F 17/30; G06F 7/00; G06F 15/18

(52) U.S. Cl. 707/6; 707/101; 706/12

(57) ABSTRACT

A data prediction method using a computer including a first memory which stores a rule showing the relationship between observation data obtained by observing an event in a first region and first attribute data representing geographical features at the observation point of the event; and a second memory which stores geographical information data on a second region different from the first region, comprises:

extracting second attribuve data representing a geographical feature of a prediction point of the event in the second region on the basis of the first attribuve data; judging the degree of agreement with the second attribute data at the prediction point according to the geographical information data and generating degree data representing the degree; converting the degree data and the second attribute data to the form of a table; adding the degree data and the second attribute data to the tabulated prediction target data, said prediction target data containing no observation data of the event at the prediction point but containing positional data defining the position of the prediction point; and analyzing the prediction target data containing the degree data and the second attribute data according to the rule, and predicting the tendency for the event to occur at the prediction point.

### CROSS-REFERENCE TO RELATED APPLICATIONS

This application is based upon and claims the benefit of priority from the prior Japanese Patent Applications No. 2002-287036, filed on Sep. 30, 2002, and No. 2002-287426, filed on Sep. 30, 2002, the entire contents of which are incorporated herein by reference.

### BACKGROUND OF THE INVENTION

1. Field of the Invention

This invention relates to a method for preparing data to be analyzed, data analysis method, data analysis device, data preparation program, data analysis program, data prediction method, data prediction device, data prediction program and computer.

2. Related Background Art

There are a spatial data mining method and a statistical analytic method as data analysis techniques for deriving spatial rules among many pieces of information in a database. Spatial data mining methods and statistical analytic methods are used to find spatial rules of data defined by two-dimensional, three-or more-dimensional spatial coordinates to be analyzed, that is, for example, in which zone of such space the data to be analyzed are densely located.

Heretofore known are methods intended to find a spatial tendency, such as a method for optimizing a target function by analyzing a distance from a given point (see Patent Document 1).

When a lot of observation data collected in a space over a wide area are analyzed, geographical features of the observation points often affect the analysis. Therefore, the addition of attribute data indicating geographical features of observation points to observation data contributes to enhancing the accuracy of data analysis.

For example, in case the tendency for traffic accidents to occur on a certain road is predicted by data analysis, attribute data such as topography of the region the road runs through, structures existing near that region, precipitation in that region, traffic flow of that region, and so on, are added to and analyzed together with observation data of actual traffic accidents. As a result, if the observation data indicating “traffic accidents are very likely to occur” are obtained when the attribute data specify “within 10 meters from a curve”, then here is obtained the rule saying “traffic accidents are very likely to occur within 10 meters from a curve”.

Such rules are usable for forecasting events which will be observed in other regions. Herein below, data used to predict events of a certain different region are called prediction target data. For predicting events from prediction target data, attribute data, which represents geographical features of prediction points where prediction is carried out, is required.

For example, in case of predicting the tendency for traffic accidents to occur on a certain point by using the rule saying “traffic accidents are very likely to occur within 10 meters from a curve”, here are required the attribute data describing whether the point is “within 10 meters from a curve” or not, and degree data indicating the degree of agreement with the attribute data. Without the attribute data and the degree data, the tendency for traffic accidents to occur is not predictable.

Referring to FIGS. 34A and 34B, existing techniques are explained below in greater detail. FIG. 34A is a schematic diagram of analysis target data. FIG. 34B is a schematic diagram of prediction target data.

By analyzing the analysis target data shown in FIG. 34A by using techniques of decision tree, neural network, regression analysis, and so on, rules characterizing the time zone of traffic accidents can be obtained. From the analysis target data shown in FIG. 34A, the following two rules are obtained.

Rule 1: Within 10 meters from a curve, the time zone of traffic accidents is night.

Rule 2: If the municipal district is city A, the time zone of traffic accidents is morning.

It is desirable to forecast the time zone of traffic accidents at a certain point of prediction by applying these rules to the prediction target data shown in FIG. 34B. However, the prediction target data shown in FIG. 34B merely include attribute data on names of the municipal districts and their degree data. That is, the prediction target data shown in FIG. 34B do not include attribute data on “whether the point is within 10 meters from a curve or not” corresponding to the analysis target data and its degree data. Therefore, the time zone of traffic accidents cannot be specified even by applying the rule 1 to the prediction target data.

Moreover, even when the prediction target data includes attribute data corresponding to the analysis target data and the degree data, rules are not applicable to the prediction target data if the attribute data and the degree data are proper names, because proper names indicate particular subjects themselves exclusively, and are not applicable to other subjects.

For example, the degree data “city A” contained in the rule 2 as well as the degree data “city X”, “city Y” and “city Z” contained in the prediction target data are proper names indicating municipal districts themselves, respectively. Therefore, it is not possible to predict observation data even by applying the rule 2 obtained from FIG. 34A to the prediction target data shown in FIG. 34B.

Positional data indicating points of observation in a space are often added to prediction target data. Under the situation, it may be possible to extract degree data by judging whether the positional data correspond to attribute data of analysis target data or not, based on geographical information data of the region including the point of prediction.

However, spatial data mining and statistical data analysis expect data in form of tables as their target of analysis. On the other hand, geographical information data such as map data, even. when computerized as well, are not tabulated. Therefore, when data mining or statistical data analysis is carried out, geographical information data cannot be applied directly to prediction target data. That is, since geographical information data and prediction target data were different in format, degree data could not be searched out or extracted from geographical information data by using a computer.

Heretofore, extraction of attribute data from spatial data such as map data relied on manpower. Therefore, data analysis based on attribute data and prediction target data could not be automated either. Work relying on manpower invites overlooking of attribute data or biased judgment of computer operators.

### SUMMARY OF THE INVENTION

An advantage of an aspect of the present invention is to provide a method of preparing analysis target data, a device for preparing analysis target data, a program for preparing analysis target data, a data analysis method, a data analysis device, a data analysis program and a computer that automatically extract attribute data necessary for analysis from geographical information data on the basis of positional data contained in observation data.

An aspect of the present invention is a method for preparing data to be analyzed by using a computer including a first memory which stores geographical information data on a geographical region, and a second memory which stores a tabulated form of observation data containing a plurality of positional data indicating locations in the geographical region and event data representing an event having occurred in the locations, comprising:

extracting attribute data representing a certain feature inside the geographical region based on the geographical information data from the first memory; obtaining degree data indicating the degree of agreement with the attribute data; converting the attribute data and the degree data to the form of a table; and preparing data for geographical information analysis used to derive a tendency for the event to occur by adding the attribute data and the degree data in form of the table to the observation data.

Another aspect of the present invention is a data analysis method using a computer including a first memory which stores geographical information data on a geographical region, and a second memory which stores a tabulated form of observation data containing a plurality of positional data indicating locations in the geographical region and event data representing an event having occurred in the locations, comprising:

extracting attribute data representing a certain feature inside the geographical region based on the geographical information data from the first memory; obtaining degree data indicating the degree of agreement with the attribute data; converting the attribute data and the degree data to the form of a table; preparing data for geographical information analysis by adding the attribute data and the degree data in form of the table to the observation data; and deriving a tendency for the event to occur by using the data for geographical information analysis.

Another aspect of the present invention is a data analysis device comprising a first memory storing geographical information data on a geographical region; a second memory storing tabulated form of observation data containing a plurality of positional data indicating locations in the geographical region and event data representing an event having occurred in the locations; a data processor extracting attribute data representing a first feature in the geographical region based on the geographical information data, said data processor preparing data for geographical information analysis by converting the attribute data and degree data to the form of a table and then adding the table to the observation data, said degree data indicating the degree of agreement with the attribute data; and a data analyzer deriving a tendency for the event to occur by-using the data for geographical information analysis.

Another aspect of the present invention is a data preparation program using a computer including a first memory which stores geographical information data on a geographical region, and a second memory which stores a tabulated form of observation data containing a plurality of positional data indicating locations in the geographical region and event data representing an event having occurred in the locations, to execute:

extracting attribute data representing a certain feature inside the geographical region based on the geographical information data from the first memory; obtaining degree data indicating the degree of agreement with the attribute data; converting the attribute data and the degree data to the form of a table; and preparing data for geographical information analysis used to derive a tendency for the event to occur by adding the attribute data and the degree data in form of the table to the observation data.

Another aspect of the present invention is a data analysis program using a computer including a first memory which stores geographical information data on a geographical region, and a second storage means which stores tabulated form of observation data containing a plurality of positional data indicating locations in the geographical region and event data representing an event having occurred in the locations, to execute:

extracting attribute data representing a first feature inside the geographical region based on the geographical information data from the first memory; obtaining degree data indicating the degree of agreement with the attribute data; converting the attribute data and the degree data to the form of a table; preparing data for geographical information analysis by adding the attribute data and the degree data in form of the table to the observation data, said data for geographical information analysis being used to derive a tendency for the event to occur; and deriving a tendency for the event to occur by using the data for geographical information analysis.

Another aspect of the present invention is a computer comprising: a processor; a storage accessible from the processor; memory accessible from the processor; data stored in the storage; and a data analysis program stored in the memory and executed by the processor,

wherein the data comprise geographical information data on a geographical region; and observation data in form of a table containing a plurality of positional data defining positions in the geographical region and event data representing an event at the position,

wherein the program comprises extracting attribute data representing a first feature inside the geographical region based on the geographical information data from the geographical information data; obtaining degree data indicating the degree of agreement with the attribute data; converting the attribute data and the degree data to the form of a table; preparing data for geographical information analysis by adding the attribute data and the degree data in form of the table to the observation data, said data for geographical information analysis being used to derive a tendency for the event to occur; and deriving a tendency for the event to occur by using the data for geographical information analysis.

Another aspect of the present invention is a data prediction method using a computer including a first memory which stores a rule showing relationship between observation data obtained by observing an event in a first region and first attribute data representing geographical features at the observation point of the event; and a second memory which stores geographical information data on a second region different from the first region, comprising:

extracting second attribute data representing a geographical feature of a prediction point of the event in the second region on the basis of the first attribute data; judging the degree of agreement with the second attribute data at the prediction point according to the geographical information data and generating degree data representing the degree; converting the degree data and the second attribute data to the form of a table; adding the degree data and the second attribute data to the tabulated prediction target data, said prediction target data containing no observation data of the event at the prediction point but containing positional data defining the position of the prediction point; and analyzing the prediction target data containing the degree data and the second attribute data according to the rule, and predicting the tendency for the event to occur at the prediction point.

Another aspect of the present invention is a data prediction device comprising: a first memory which stores a rule showing the relationship between observation data obtained by observing an event in a first region and first attribute data representing geographical features at the observation point of the event; a second memory storing geographical information data on a second region different from the first region; a data processor extracting second attribute data representing a geographical feature of a prediction point of the event in the second region on the basis of the first attribute data; generating degree data representing the degree of agreement with the second attribute data at the prediction point according to the geographical information data; converting the degree data and the second attribute data to the form of a table; and adding the second attribute data and the degree data to the tabulated prediction target data, said prediction target data containing positional data defining the position of the prediction point but not containing observation data of the event at the prediction point; and a data analyzer analyzing the prediction target data containing the second attribute data and the degree data according to the rule, and thereby predicting the tendency for the event to occur at the prediction point.

Another aspect of the present invention is a data prediction program using a computer including a first memory which stores a rule showing relationship between observation data obtained by observing an event in a first region and first attribute data representing geographical features at the observation point of the event; and a second memory which stores geographical information data on a second region different from the first region, to execute:

extracting second attribute data representing a geographical feature of a prediction point of the event in the second region on the basis of the first attribute data; judging the degree of agreement with the second attribute data at the prediction point according to the geographical information data and generating degree data representing the degree; converting the degree data and the second attribute data to the form of a table; adding the degree data and the second attribute data to the tabulated prediction target data, said prediction target data containing no observation data of the event at the prediction point but containing positional data defining the position of the prediction point; and analyzing the prediction target data containing the degree data and the second attribute data according to the rule, and predicting the tendency for the event to occur at the prediction point.

Another aspect of the present invention is a computer comprising: a processor; a storage accessible from the processor; memory accessible from the processor; data stored in the storage; and a data analysis program stored in the memory and executed by the processor,

wherein the data comprise rule data showing the relationship between observation data obtained by observing an event in a first region and first attribute data representing geographical features at the observation point of the event; observation data in form of a table containing a plurality of positional data defining positions in the region and event data representing an event at the position; and geographical information data of a second region different from the first region,

wherein the program comprises extracting second attribute data representing a geographical feature of a prediction point of the event in the second region on the basis of the first attribute data; judging the degree of agreement with the second attribute data at the prediction point according to the geographical information data and generating degree data representing the degree; converting the degree data and the second attribute data to the form of a table; adding the degree data and the second attribute data to the tabulated prediction target data, said prediction target data containing no observation data of the event at the prediction point but containing positional data defining the position of the prediction point; and analyzing the prediction target data containing the degree data and the second attribute data according to the rule, and predicting the tendency for the event to occur at the prediction point.

### BRIEF DESCRIPTION OF THE DRAWINGS

FIG. 1 is a block diagram of a data analysis device 100 according to an embodiment of the invention

FIG. 2 is a schematic diagram showing an example of observation data;

FIG. 3 is a schematic diagram showing an example of data for geographical information analysis;

FIG. 4A is schematic diagram of geographical information data according to the first embodiment;

FIG. 4B is a schematic diagram of data for geographical information analysis according to the first embodiment;

FIG. 5 is a flow chart of the data analysis method according to the first embodiment;

FIG. 6A is a schematic diagram of geographical information data according to the second embodiment;

FIG. 6B is a schematic diagram of data for geographical information analysis according to the second embodiment;

FIG. 7 is a flow chart of a data analysis method according to the second embodiment;

FIG. 8 is a block diagram of a data analysis device 200 according to the third embodiment of the invention;

FIG. 9A is a schematic diagram of a data analysis method according to the third embodiment;

FIG. 9B is a schematic diagram of the data analysis method according to the third embodiment;

FIG. 10A is a schematic diagram showing a process of preparing a decision tree;

Fig. 10B is a schematic diagram showing the process subsequent to Fig. 10A;

Fig. 10C is a schematic diagram showing the process subsequent to Fig. 10B;

FIG. 11 is a flow chart of the data analysis method according to the third embodiment;

FIG. 12 is a block diagram of a data analysis device 300 according to the third embodiment;

FIG. 13 is a schematic diagram of a data analysis method according to the fourth embodiment of the invention;

FIG. 14 is a flow chart of the data analysis method according to the fourth embodiment;

FIG. 15 is a block diagram of a data prediction device 500 according to the fifth embodiment of the invention;

FIG. 16 is a schematic diagram of an example of geographical information data of a first region;

FIG. 17 is a schematic diagram of an example of analysis target data;

FIG. 18 is a schematic diagram showing an aspect of positional data shown in FIG. 17 plotted on map data shown in FIG. 16;

FIG. 19 is a schematic diagram of an example of geographical information data added with attribute data;

FIG. 20 is a schematic diagram of an example of geographical information data of a second region;

FIG. 21 is a schematic diagram of an example of prediction target data;

FIG. 22 is a schematic diagram showing an aspect of positional data shown in FIG. 21 plotted on map data shown in FIG. 20;

FIG. 23A is a schematic diagram of an example of prediction target data added with attribute data;

FIG. 23B is a schematic diagram showing an example of prediction target data having prediction result data;

FIG. 24 is a block diagram of an embodiment commonly using identical components of a rule generator 101 and a prediction generator 102;

FIG. 25 is a flow chart showing the flow of the process according to the fifth embodiment;

FIG. 26 is a flow chart showing the flow of the process according to the sixth embodiment;

FIG. 27 is a schematic diagram showing proper names of municipal districts and features of the municipal districts in form of a table;

FIG. 28A is a schematic diagram of prediction target data according to the sixth embodiment;

FIG. 28B is a schematic diagram of prediction target data already analyzed;

FIG. 29 is a flow chart showing the flow of the process according to the seventh embodiment;

FIG. 30 is a flow chart showing the floor of the process according to the eighth embodiment;

FIG. 31 is a schematic diagram of map data for a road construction plan used in the eighth embodiment;

FIG. 32 is a diagram of point 21 to point 25 in a virtual positional data plotted on the map data of FIG. 31;

FIG. 33A is a schematic diagram of prediction target data according to the eighth embodiment;

FIG. 33B is a schematic diagram of prediction result data;

FIG. 34A is a schematic diagram of analysis target data; and

FIG. 34B is a schematic diagram of prediction target data.

### DETAILED DESCRIPTION OF THE INVENTION

Some embodiments of the invention will now be described below. These embodiments, however, do not limit the present invention.

(First Embodiment)

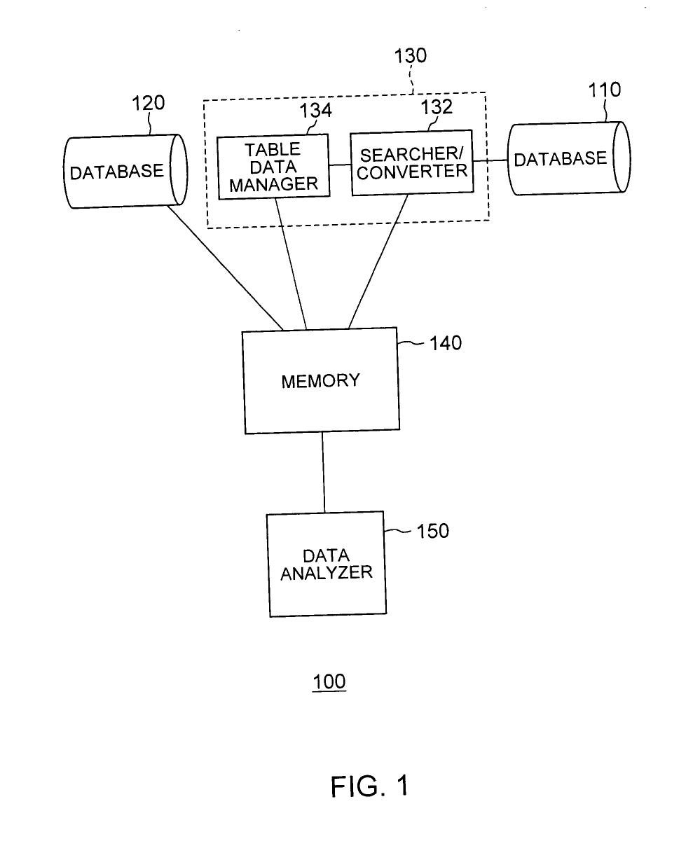

FIG. 1 is a block diagram of a data analysis device 100 according to an embodiment of the invention. The data analysis device 100 includes a database 110 storing geographical information data on a certain region and a database 120 storing observation data in form of a table.

Geographical information data is a kind of data describing a one- or more-dimensional space. Typically, it is data showing a two-dimensional space and a three-dimensional space in a vector form or a graphic form. For example, geographical information data is map data, GIS (geographical information system) data, or the like.

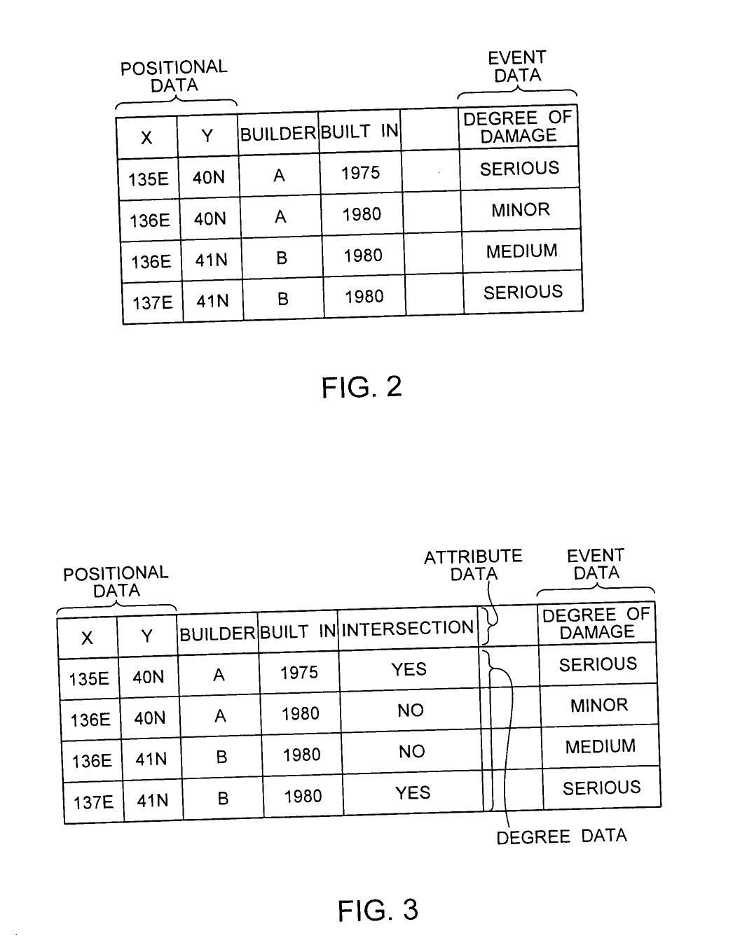

Observation data are a kind of data describing positional data indicating positional coordinates in the region and event data indicating an event having occurred at those positions. For example, observation data obtained by observing the degree of damage of roads in the region is taken of this observation data. In this case, positional data represent coordinates of points of observation on roads, and event data represent the degree of damage of the roads at the points of observation (see FIG. 2).

FIG. 2 is a schematic diagram showing an example of observation data. This observation data indicate the degree of damage of roads. In this embodiment, positional data are coordinates (X, Y) on the roads. Positional data may alternatively describe positional coordinates in the region and may be reworded as a positional attribute. Event data indicate degrees (serious, medium, minor) of damage of the roads at individual coordinates. Event data may be reworded as a class attribute. Observation data further include names of road constructors and fiscal years of construction of the roads.

Again referring to FIG. 1, the data analysis device 100 further includes a data processor 130 for preparing data for geographical information analysis on the basis of geographical information data and observation data; memory 140 capable of temporally storing data such as observation data or data for geographical information analysis; and data analyzer 150 that analyzes data for geographical information analysis and predicts the tendency for the event to occur. The data analysis technique is, for example, spatial data mining or statistical analysis. The tendency for an event to occur is the tendency for a certain event to occur in a space, such as “a road with a heavy traffic volume is seriously damaged”.

The data processor 130 includes a searcher/converter 132 for searching a certain feature of the region from the database 110 and converting the feature to attribute data in form of a table; and a table data manager 134 for adding the attribute data to the observation data as an item. The table data manager 134 further adds degree data, which indicate the degree of agreement with the feature at the each positional data, to the observation data. Data for geographical information analysis are built by adding the attribute data and the degree data to the observation data (see FIG. 3).

FIG. 3 is a schematic diagram showing an example of data for geographical information analysis. Data for geographical information analysis are a kind of data in form of a table prepared by adding attribute data and degree data to observation data. Data for geographical information analysis include attribute data as an item, and describes degree data for individual positional data for this item. The data for geographical information analysis are prepared for the purpose of analysis.

Attribute data are a kind of data describing an arbitrary feature of certain positions in the region, and it may be reworded as attribute names. Examples of possible attribute data are “there is an intersection within 10 meters from a certain position”, “there is a curve within 10 meters from a certain position”, “traffic volume of a certain position”, “population of a municipal district of such a position belongs to”, and so forth.

Degree data are a kind of data representing degrees of agreement with attribute data for individual positional data, and it may be reworded as attribute values. That is, degree data represent degrees such as the presence or absence, or numerical values, of a feature described by the attribute data in individual positional data. For example, an attribute data describes “there is an intersection within 10 meters from a certain position”, if coordinates of an intersection reside within 10 meters from coordinates of a positional data, then the degree data is “yes”. If coordinates of an intersection do not reside within 10 meters from coordinates of a positional data, then the degree data is “no”. In case an attribute data describes “a traffic volume of a certain position”, a degree data is a numerical value of the traffic volume on coordinates of the positional data. Therefore, degree data may be either binary data of yes and no, or a continuous data like traffic volume.

Attribute data may include a plurality of different kinds of data. If so, items equal in number to attribute data are added to observation data, and degree data equal in number to attribute data are added to observation data in association with individual positional data.

Observation data collected by observation, are represented as tuples of attribute name (attribute data) and attribute value (degree data). Data for geographical information analysis are also represented as tuples of attribute name and attribute value, which were prepared for analysis.

In this fashion, the data analysis device 100 prepares data for geographical information analysis by adding attribute data based upon geographical information data and degree data representing degrees of agreement with the attribute data to observation data.

Data for geographical information analysis undergo data analysis by the data analyzer 150. As a result of the analysis of the data for geographical information analysis, a tendency regarding the attribute data is obtained. For example, from the data of geographical information analysis shown in FIG. 3, the tendency that “damage of roads is serious within 10 meters from an intersection” is obtained.

The data processor 130 and the data analyzer 150 can be realized by the use of CPU of a computer. The data analysis device 100 may be a system including the database 110, database 120, data processor 130, memory 140 and data analyzer 150 that are independent but connected together for mutual communication. Alternatively, the data analysis device 100 may be a workstation, for example, which incorporates the database 110, database 120, data processor 130, memory 140 and data analyzer 150 altogether.

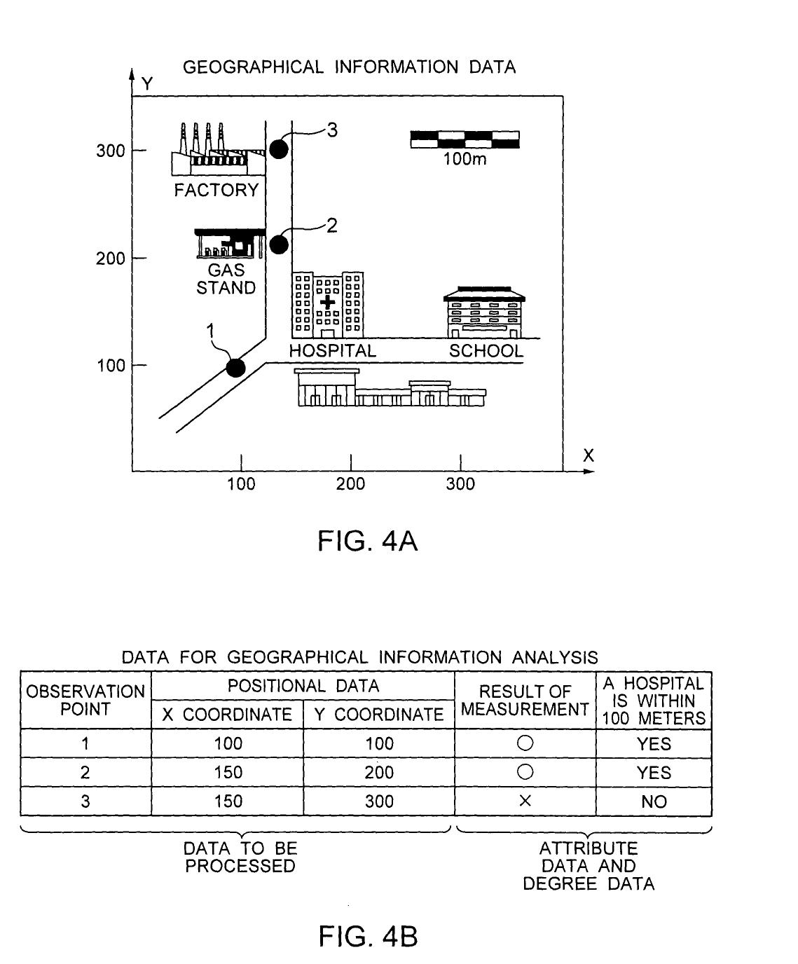

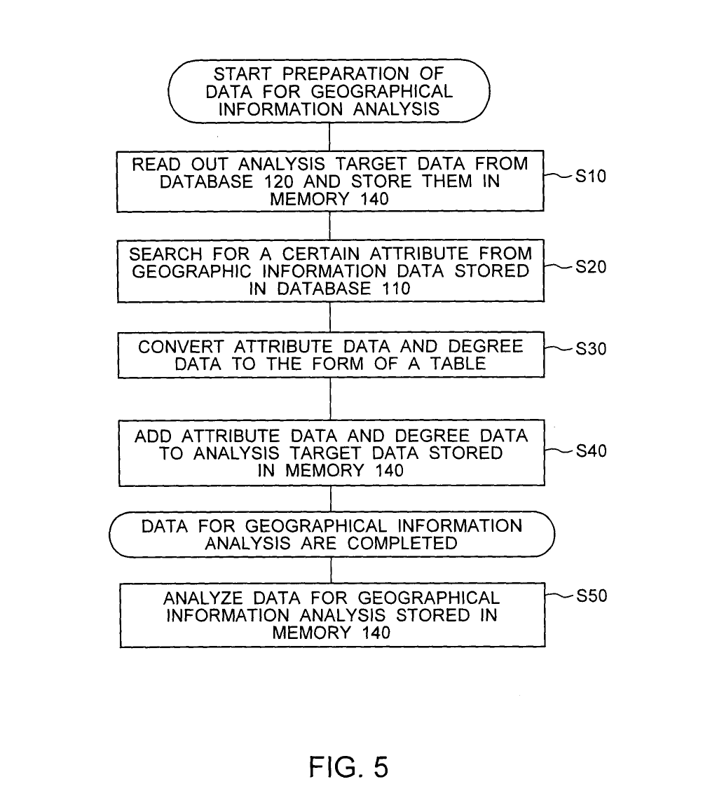

FIG. 4A is a schematic diagram of geographical information data in the data analysis method according to the first embodiment. FIG. 4B is a schematic diagram of data for geographical information analysis according to the first embodiment. FIG. 5 is a flow chart of the data analysis method according to the first embodiment.

This data analysis method can be executed by using the data analysis device 100.

The geographical information data shown in FIG. 4A are stored in the database 110, and the part of observation data in the data for geographical information analysis shown in FIG. 4B are stored in the database 120. In the instant embodiment, the geographical information data are map data of a certain region. Observation is carried out at observation points 1 through 3 indicated in the map data, and results of measurement are shown in the observation data. The observation data exhibit coordinates (X, Y) as individual positional data of observation points 1 through 3. Additionally, here are shown results of measurement (o or x) at observation points 1 through 3.

For example, the present embodiment assumes that the observation data comprise degrees of damage of roads at observation points 1 through 3, respectively. In this case, “O” is assigned to the result of measurement of an observation point exhibiting a degree of damage heavier than a predetermined reference level, and “x” is assigned to the result of measurement of an observation point exhibiting a degree of damage minor than the predetermined reference level.

The data processor 130 reads out observation data from the database 120, and stores it in the memory 140 (S10)

After that, the searcher/converter 132 performs a search to find a certain feature from the geographical information data stored in the database 110 (S20). In this search, arbitrary features are preferably searched from the geographical information data stored in the database 110. However, attribute data already known as not producing any tendency as a result of data analysis are not selected. For example, in case that degree data is identical for all positional data, no tendency can be obtained by data analysis. Therefore, degree data on a certain feature are judged, and if it results in the same attribute data for all positional data, then the attribute data are not selected.

In greater detail, in case the attribute data describe “there is a school within 100 meters” in FIG. 4, any of the positions from data numbers 1 to 3 does not exist within 100 meters from the school. Therefore, the degree data represent “no” for all positional data. As a result, even if the data analyzer 150 analyzes data for geographical information analysis, no tendency is obtained. As such, attribute data bringing about identical degree data for all positional data are not selected.

As shown in the data for geographical information analysis in FIG. 4B, the attribute data describing “there is a hospital within 100 meters” is selected. In this case, the degree data are “yes” at observation point 1 and observation point 2, and “no” at observation point 3. The degree data can be prepared, for example, by calculating distances from the coordinates of the position of the hospital to coordinates of observation points 1 through 3 and reviewing whether the distances are equal to or shorter than 100 meters, or not.

After that, the searcher/converter 132 converts the attribute data and the degree data to the form of a table (S30). Since the observation data also has the form of a table, the attribute data and the degree data having been converted to the form of a table can be added to the observation data.

In the next step, the data processor 130 adds the attribute data and the degree data to the observation data stored in the memory 140 (S40). Thus the data for geographical information analysis is completed.

Further, the data analyzer 150 analyzes the data for geographical information analysis stored in the memory 140 (S50). As a result, the tendency that “the degree of damage of roads having a hospital within 100 meters is equal to or heavier than the predetermined reference level” is obtained, for example.

The instant embodiment uses only three observation points; however, observation data preferably include results of measurement at more observation points. Thereby, more accurate tendency can be obtained from the data for geographical information analysis. In this embodiment, the attribute data are information about distances from geographical coordinates shown by the positional data to a hospital.

Another example of the attribute data on distances from positions shown by the positional data may be, for example, “there is T within S meters around”. In this case, if both S and T are constants, then the degree data are “yes” when T resides within S meters from coordinates indicated by the positional data. Otherwise, the degree data are “no”. That is, if both S and T are constants, then the degree data are binary information. If S is a variable and T is a constant, then the degree data show distances from coordinates indicated by the positional data to T. That is, when S is a variable and T is a constant, the degree data are numerical information. In case S is a constant and T is a variable, then the degree data are structures existing within S meters from coordinates indicated by the positional data, and it is many-valued information like hospitals, factories, department stores, or the like.

Alternatively, the description “there is Q within P meters north” may be employed as attribute data. In case that Q is a constant and P is a constant, or Q is a constant and P defines a certain range, the degree data are “yes” when Q resides within P meters north of the coordinates indicated by the positional data. Otherwise, the degree data are “no”. That is, when P and Q are constants, or P defines a certain range while Q is a constant, the degree data are binary information. When P is a variable and Q is a constant, the degree data exhibit distances from coordinates indicated by the positional data to Q. That is, when P is a variable and Q is a constant, the degree data are numerical information. When P is a constant and Q is a variable, the degree data indicate things existing within Q meters north of coordinates indicated by the positional data, and it is many-valued information.

In the above example, the attribute data pertain to distances from a geographical position indicated by the positional data. However, the attribute data may describe any feature regarding geographical distribution, not limited to those distances.

For example, a feature about distribution of a certain condition in a region involved in the geographical information data, namely, data on distribution of population density of the region involved in the geographical information data, may be stored in the database 110 beforehand, and the description “population density is n” may be employed as attribute data. In case that n is a constant or indicates a certain range, the degree data are “yes” when the population density at coordinates indicated by the positional data corresponds to the attribute data. Otherwise, the degree data are “no”. That is, when n is a constant or indicates a certain range, the degree data is binary information. When n is a variable, the degree data are a numerical value of the population density of coordinates defined by the positional data. That is, when n is a variable, the degree data are numerical information.

Alternatively, the description “the traffic volume is V or more at the point of time U” may be employed as the attribute data. V is a constant. In this case, if U is a constant or indicates a certain range, the degree data are “yes” when the traffic volume at coordinates defined by the positional data is V or more. Otherwise, the degree data are “no”. That is, when U is a constant, the degree data are binary information. If U is a variable, the degree data are the date and time where the traffic volume at coordinates defined by the positional data is V or more. That is, when U is a variable, the degree data are continuous information.

Of course, the degree data may be any of three or more discrete values. For example, in case the attribute data describe “the population density is n” and n defines a certain range, the degree data are “high” when the population density at coordinates defined by the positional data is higher than the range defined by n. If the population density falls within the range defined by n, the degree data are “medium”. If the population density is lower than the range defined by n, the degree data are “low”. In this manner, the degree data can be three-valued information.

According to the instant embodiment, it is possible to extract attribute data required for analysis of geographical information data on the basis of positional data and to automatically convert the attribute data and corresponding degree data to the form of a table. Thereby, the data analysis device 100 can prepare data for geographical information analysis by adding attribute data and corresponding degree data to analysis target data (i.e. observation data). Then, the data analyzer 150 can carry out data analysis such as spatial data mining or statistical analysis on the data for geographical information analysis to know the tendency of occurrence of an event in the region.

According to the instant embodiment, it is possible to automatically extract attribute data required for analysis from geographical information data on the basis of positional data contained in observation data and to automatically execute data analysis based on the attribute data and the observation data.

(Second Embodiment)

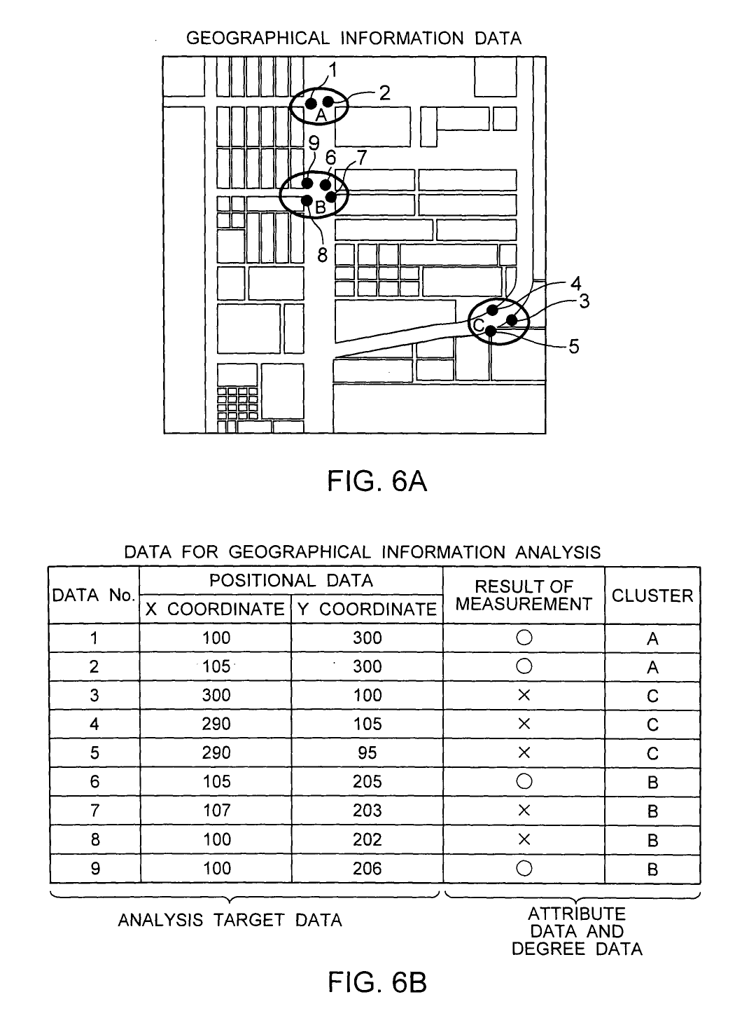

FIG. 6A is a schematic diagram of geographical information data according to the second embodiment. FIG. 6B is a schematic diagram of data for geographical information analysis according to the second embodiment. The data analysis method shown here can be carried out by using the data analysis device 100. This data analysis method progresses substantially identically to the flow chart shown in FIG. 5; however, it is different in step S20 where the data processor 130 adds attribute data and degree data to observation data by additionally using clustering processing.

The data processor 130 plots coordinates defined by positional data contained in observation data on geographical information data, and makes a plurality of clusters by associating different positional data that are close in distance. In this embodiment, attribute data are clusters, and degree data are names of clusters to which individual positional data belong.

For example, as shown in FIG. 6A, coordinates (X, Y) defined by positional data from data numbers 1 through 9 are plotted on the geographical information data. Once these positional data undergo clustering processing, three clusters A, B and C are formed. If the attribute data show clusters, then the degree data indicate the name of a cluster to which individual positional data belong, that is, one of clusters A, B and C. These procedures are executed by the data processor 130. Clustering processing may be executed by the data analyzer 150.

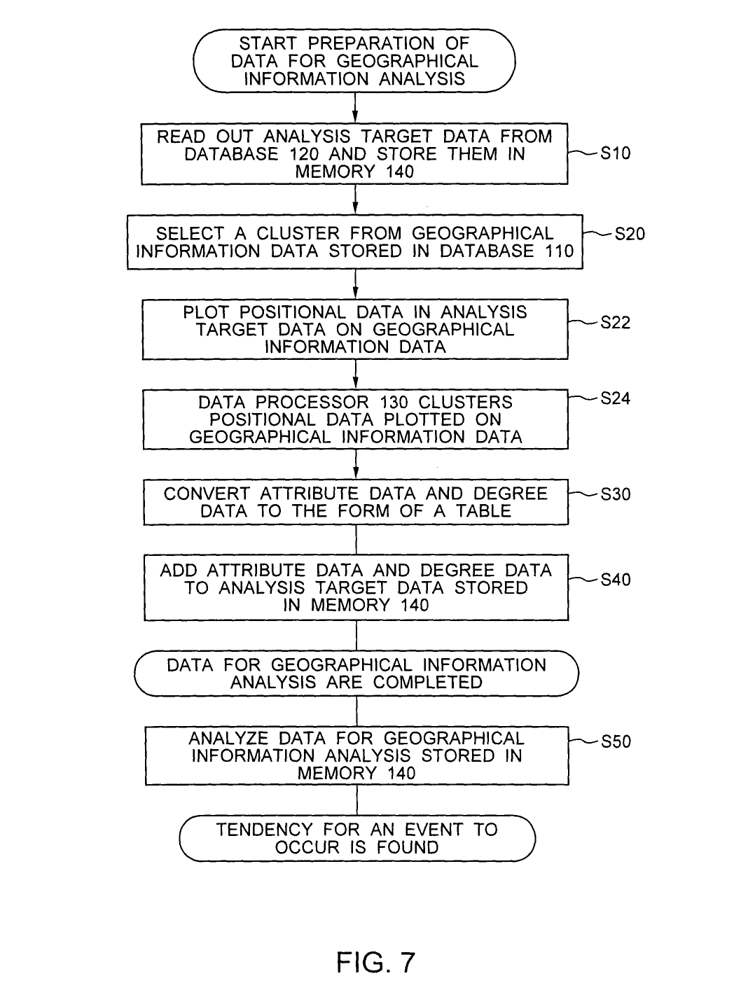

FIG. 7 is a flow chart of a data analysis method according to the second embodiment. In step S20 of the first embodiment, clusters are selected as attribute data. After that, the data processor 130 plots positional data of data numbers 1 through 9 on geographical information data (S22). Points 1 through 9 shown on the geographical information data of FIG. 6A are positional data plotted in step S22.

In the next step, the positional data plotted on the geographical information data undergo clustering (S24). As a result, observation data of data numbers 1 through 9 are clustered to cluster A, B or C, based on the geographical information data.

After that, clusters employed as attribute data as well as names of clusters to which individual positional data belong, which are employed as degree data, are converted to the form of a table (S30).

After that, the attribute data and the degree data are added to the observation data (S40). As a result, data for geographical information analysis are completed. As such, the instant embodiment enables preparation of data for geographical information analysis shown in FIG. 6B by additional use of clustering processing.

Furthermore, similarly to the first embodiment, the data analyzer 150 executes data analysis (S50). Once the data analyzer 150 analyzes the data for geographical information analysis shown in FIG. 6B, a tendency, for example, saying “degree of damage of roads is beyond a reference level at and around cluster A” is obtained.

In this embodiment, attribute data are clusters, and degree data are names of clusters. However, other geographical features of points where clusters are located may be employed in lieu of clusters as attribute data and degree data. Geographical features are those common to the positional data belonging to a common cluster. For example, employing the attribute data describing “constructions existing within 100 meters commonly”, names of the constructions existing within 100 meters from all positional data in a common cluster are added as degree data instead of the cluster A, B or C to observation data. Thereby, names contained in the geographical information data can be used as degree indicative data.

Alternatively, a feature that a representative point of each cluster has may be employed as attribute data and degree data. A representative point may be coordinates of one positional data in a certain cluster, or may be average coordinates obtained by averaging all positional data in the cluster. For example, in case the attribute data describe “constructions within 100 meters commonly”, names of constructions existing within 100 meters from a representative point of a cluster are added as degree data instead of the name of the cluster to the observation data.

Each single cluster may be replaced by a plurality of attribute data as well. For example, a certain cluster may be replaced by two attribute data describing “constructions existing within 100 meters” and “near a river”. In this case, the attribute data include two items. The degree data are names of constructions existing within 100 meters from positional data in the cluster, and “yes” or “no” indicating whether they are near a river or not. These two degree data are added to respective items for each positional data. The instant embodiment ensures the same effects as those of the first embodiment.

(Third Embodiment)

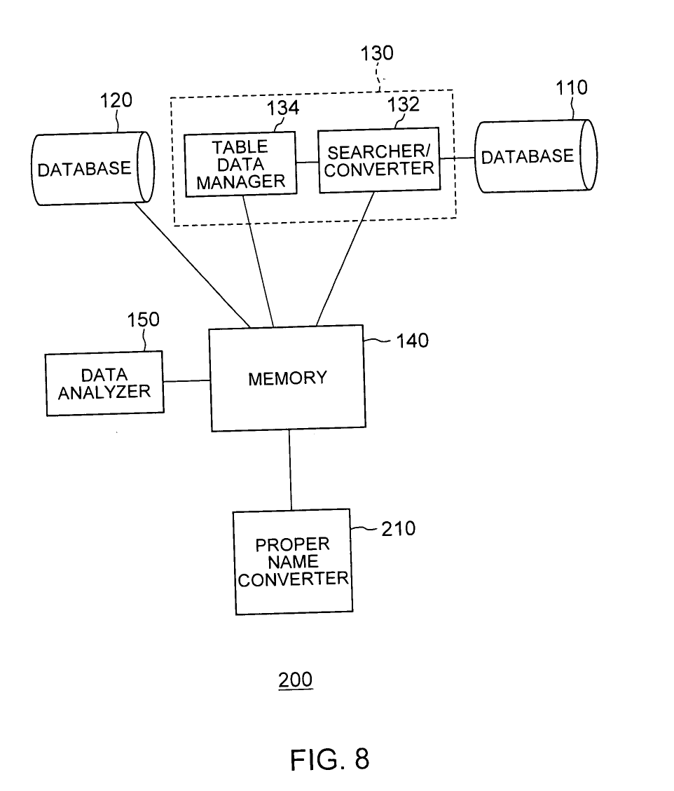

FIG. 8 is a block diagram of a data analysis device 200 according to the third embodiment of the invention. The data analysis device 200 further includes a proper name converter 210, and it is different from the data analysis device 100 in this respect. When a proper data (such as a proper name) indicating a location on a map in the geographical information data is contained, the proper name converter 210 converts it to a plurality of searchable data.

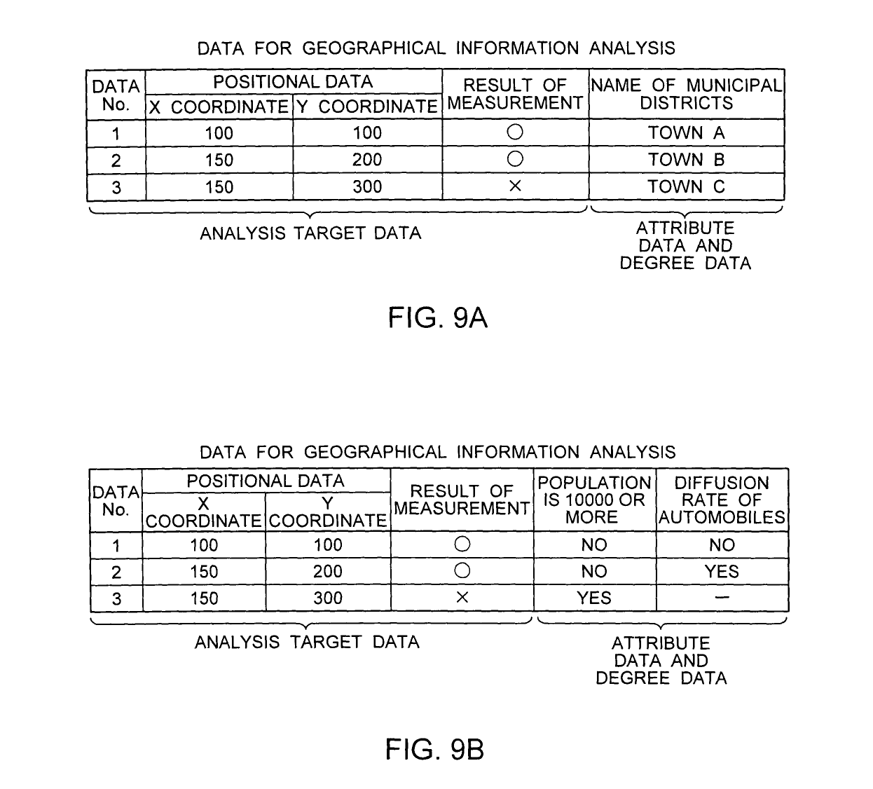

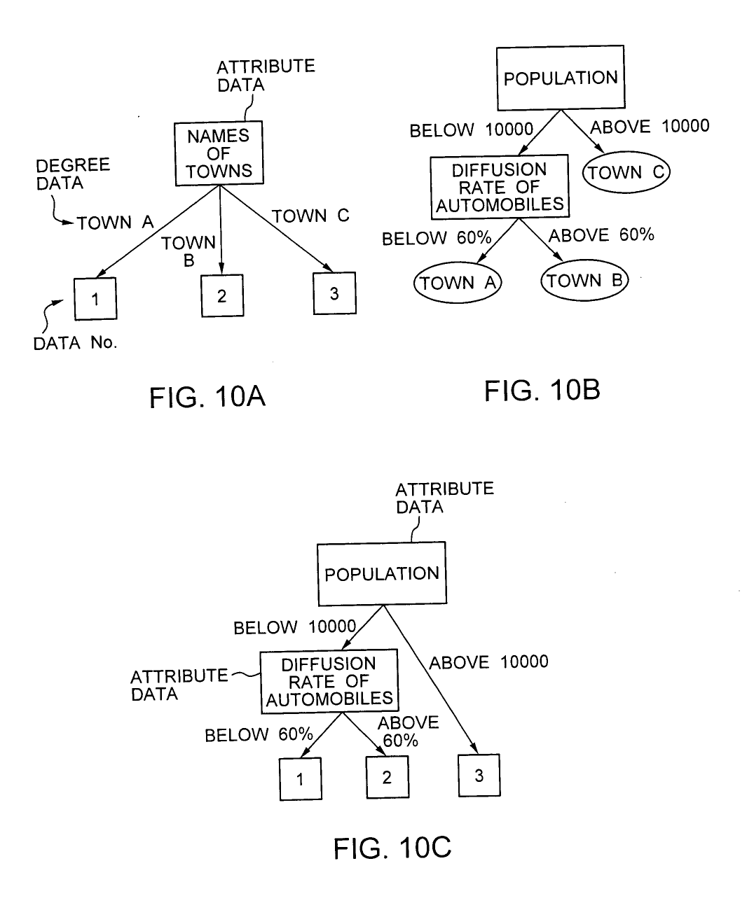

FIGS. 9A through 10C are schematic diagrams of a data analysis method according to the third embodiment. FIG. 9A is a schematic diagram of data for geographical information analysis containing proper names of municipal districts as attribute data. FIG. 9B is a schematic diagram of data for geographical information analysis obtained by processing the data for geographical information analysis shown in FIG. 9A with the proper name converter 210. FIGS. 10A through 10C are schematic diagrams showing the process of breaking off proper names by means of a decision tree.

The attribute data of the data for geographical information analysis of FIG. 9A are names of municipal districts, and the corresponding degree data are a concrete name of a district. In case the data for geographical information analysis of FIG. 9A undergoes data analysis, results of measurement in town A and town B exhibit “o” whereas the result of measurement in town C is “x”. However, any feature common to town A and town B is unknown, it is still unknown why the results of measurement exhibit “o”. That is, since the names of the municipal districts are proper names indicating the municipal districts themselves, no proper tendency can be obtained even by analyzing the data for geographical information analysis containing the names of the municipal districts by the data analyzer 150.

To cope with this problem, names of municipal districts in the attribute data and the degree data shown in FIG. 9A are converted to searchable data enabling names of a plurality of municipal districts to be searched out from the database 110, namely, attribute data and degree data describing general features, by using a decision tree as shown in FIGS. 10A through 10C.

FIG. 10A shows relations among data numbers, attribute data and degree data shown in FIG. 9A. Degree data of data numbers 1, 2 and 3 are town A, town B and town C, respectively.

As shown in Fig. 10B, using a decision tree having town names at end nodes, town A, town B and town C are distinguished by two features, “population” and “diffusion rate of automobiles”. The feature that the population of the town is 10,000 or more distinguishes town C from town A and town B, and the feature that the diffusion rate of automobiles is 60% or more distinguishes town A and town B from each other.

When the decision tree shown in FIG. 10B is inserted instead of the attribute data shown in FIG. 10A, the decision tree shown in FIG. 10C is formed. Data for geographical information analysis prepared on the basis of the decision tree shown in FIG. 10C are shown in FIG. 9B. Once the data analyzer 150 analyzes the data for geographical information analysis shown in FIG. 9B, an adequate tendency can be obtained. According to the instant embodiment, the tendency that “the result of measurement is “o” when the population is 10,000 or less” is obtained.

In the instant embodiment, the database 110 stores distribution data of population and distribution data of automobile diffusion rate corresponding to geographical information data beforehand, and the searcher/converter 132 extracts populations and automobile diffusion rates of town A, town B and town C. Although this embodiment uses combination of two features as attribute data (i.e. population and automobile diffusion rate), one feature or combination of three or more features may be used as attribute data.

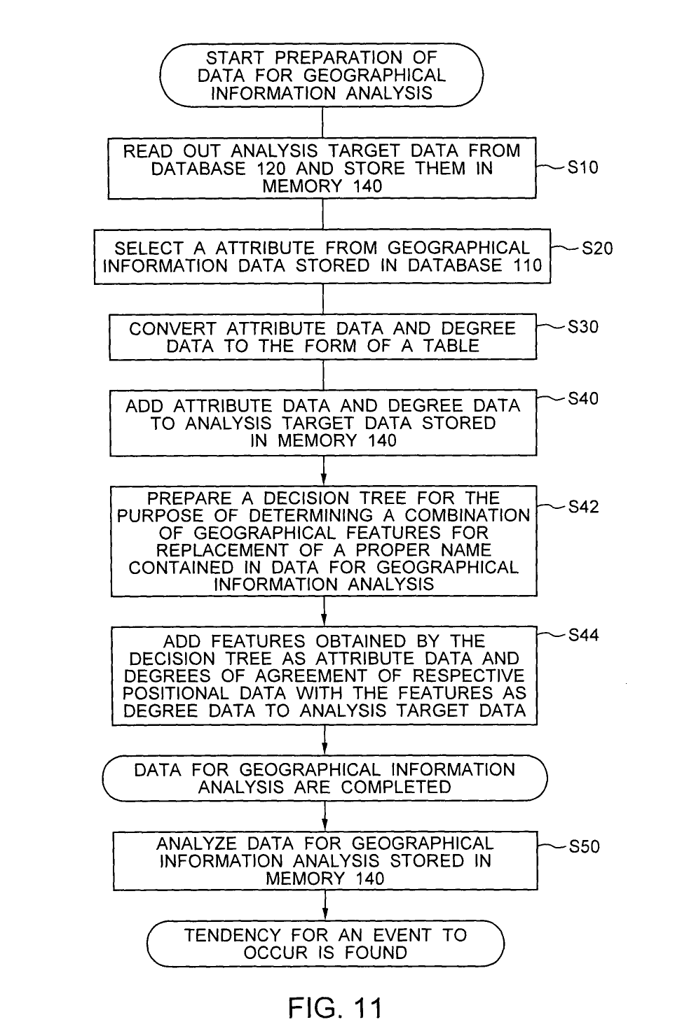

FIG. 11 is a flow chart of the data analysis method according to the third embodiment. The flow of this embodiment from step S10 to step S40 is identical to the flow shown in FIG. 5.

Subsequently, the proper name converter 210 prepares a decision tree for determining a combination of geographical features in lieu of proper names contained in the data for geographical information analysis (S42).

After that, features obtained through the decision tree prepared by the proper name converter 210 are employed as attribute data respectively, and degrees of coincidence with features for individual positional data are added as degree data to observation data (S44). Thus the data for geographical information analysis are completed.

Once the data analyzer 150 analyzes the data for geographical information analysis, a tendency for an event to occur is found.

The instant embodiment ensures the same effects as those of the first embodiment. Additionally, according to the instant embodiment, since proper data representing a point on a map in the data for geographical information analysis, such as a proper name, is converted to a searchable data, a more adequate tendency can be found by data analysis of the data for geographical information analysis by the data analyzer 150.

The method according to the second embodiment already explained employs clusters as attribute data. The third embodiment, however, may convert the clusters to combinations of other geographical features. In this case, a geographical feature common to all observation data belonging to cluster A shown in FIG. 6 may be employed as attribute data.

(Fourth Embodiment)

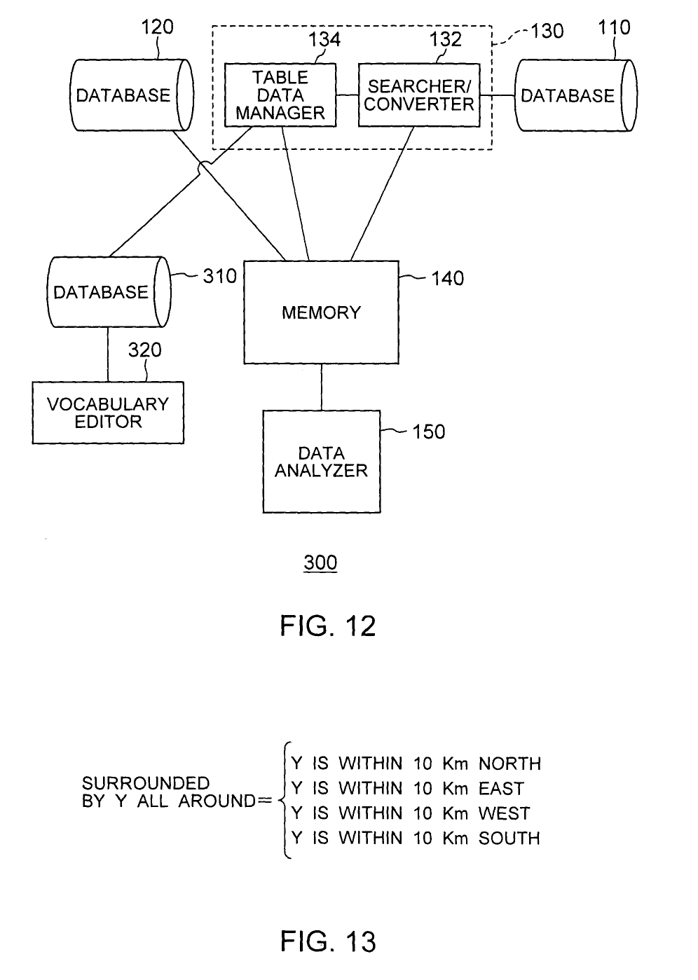

FIG. 12 is a block diagram of a data analysis device 300 according to the fourth embodiment. The data analysis device 300 additionally includes a database 310 storing vocabulary data and a vocabulary editor 320, and it is different from the data analyzer 100 in this respect. The database 310 stores previously non-searchable vocabularies other than items contained in the geographical information data. The database 310 stores also previously automatically searchable vocabularies which are identical to items of geographical information data corresponding to the said non-searchable vocabulary. The vocabulary editor 320 is configured to convert a non-searchable vocabulary to a combination of automatically searchable vocabularies.

FIG. 13 is a schematic diagram of a data analysis method according to the fourth embodiment of the invention. This data analysis method can be executed by the data analysis device 300. Similarly to the third embodiment, the data analysis method shown here replaces automatically a non-searchable vocabulary contained in the data for geographical information analysis with automatically searchable expressions.

For example, in case the attribute data describes “surrounded all around by Y”, there is no basis in the mode of surrounding all around. Therefore, data for geographical information analysis containing this kind of attribute data is not automatically searchable, and therefore unavailable for data analysis. To cope with it, four vocabularies, describing “Y is within 10 kilometers north”, “Y is within 10 kilometers east”, “Y is within 10 kilometers west” and “Y is within 10 kilometers south”, are registered beforehand in the database 310 in association with “surrounded all around by Y”. The vocabulary editor 320 reads those four vocabularies out of the database 310 and combines them to cope with the vocabulary “surrounded all around by Y”. Using the combination of those four vocabularies as attribute data, data for geographical information analysis are prepared. As a result, the data for geographical information analysis become available for data analysis by the data analyzer 150.

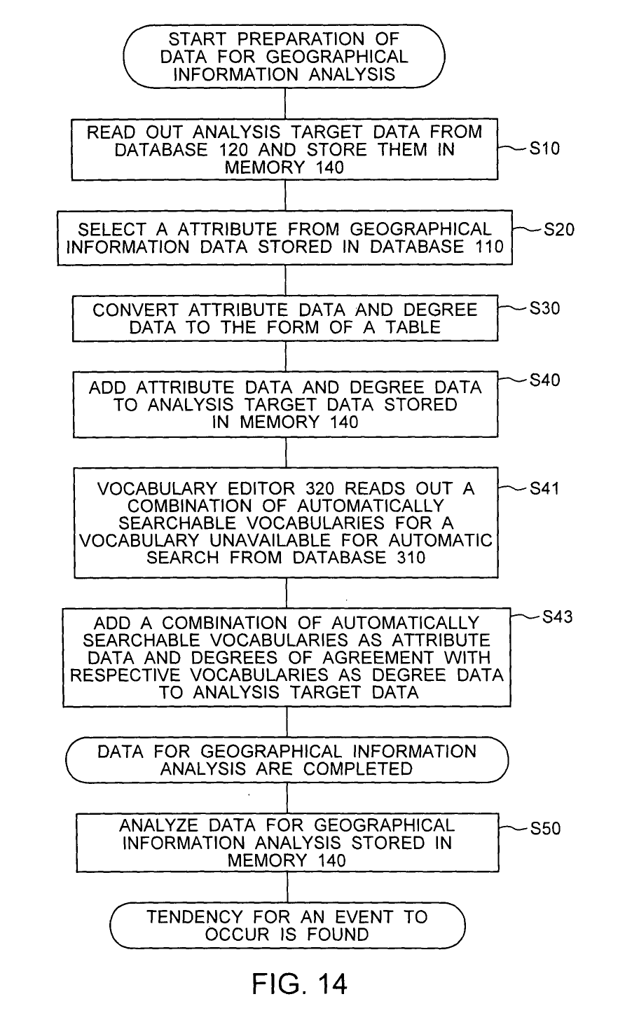

FIG. 14 is a flow chart of the data analysis method according to the fourth embodiment. The flow of this embodiment from step S10 to step S40 is identical to the flow shown in FIG. 5.

Subsequently, the vocabulary editor 320 reads out a combination of automatically searchable vocabularies from the database 310 for the sake of an automatically non-searchable vocabulary (S41).

After that, the combination of the automatically searchable vocabularies is employed as attribute data, and degrees of correspondence to the respective vocabularies are employed as degree data. The attribute data and the degree data are added to observation data (S43). Thus the data for geographical information analysis are completed.

Furthermore, the data analyzer 150 carries out data analysis of the data for geographical information analysis (S50). As a result, a tendency for an event to occur is found. The instant embodiment ensures the same effects as those of the first embodiment.

According to the embodiments described above, it is possible to automatically prepare data for geographical information analysis by converting geographical information data different in format to the form of a table and adding it to observation data. Then by analyzing the data for geographical information analysis by spatial data mining or statistical analysis, a tendency for an event to occur can be derived. This tendency is expressed according to the IF-THEN rule, for example.

This tendency is usable to predict a tendency for the same event to occur in another region (called the second region) different from the very region (called the first region) indicated by the geographical information stored in the database 110.

Assume, for example, that observation about the degree of damage of roads is not yet carried out in the second region. In this case, although the prediction target data to be predicted include positional data, they do not include event data indicating the degree of damage of roads, unlike the observation data shown in FIG. 2.

Under the condition, based on the attribute data contained in the data for geographical information analysis, degree data corresponding to respective positional data in the prediction target data are added to the prediction target data. For example, the attribute data describing “there is an intersection within 10 meters”, as well as the degree data saying “o” upon agreement with the attribute data and “x” upon disagreement with the attribute data are added to the prediction target data. Then, the tendency obtained by analyzing the data for geographical information analysis of the first region is applied to the prediction target data having degree data. For example, the tendency that “degree of damage of roads is serious when having an intersection within 10 meters” is applied to the prediction target data. As a result, the degree of damage of roads in the second region is known from the degree data contained in the prediction target data.

In this manner, based on the tendency regarding the attribute data obtained from the data analysis device, an event not observed actually can be predicted. The result data obtained by the prediction are useful for predicting positions of roads that need mending, for example.

(Fifth Embodiment)

Next explained are further embodiments of the data prediction device, which use the tendency in the first region obtained by the first to fourth embodiments to predict the tendency for the same event to occur in the second region. In the following embodiments, the tendency for an event to occur is the IF-THEN rule (herein below called “logical rule” as well).

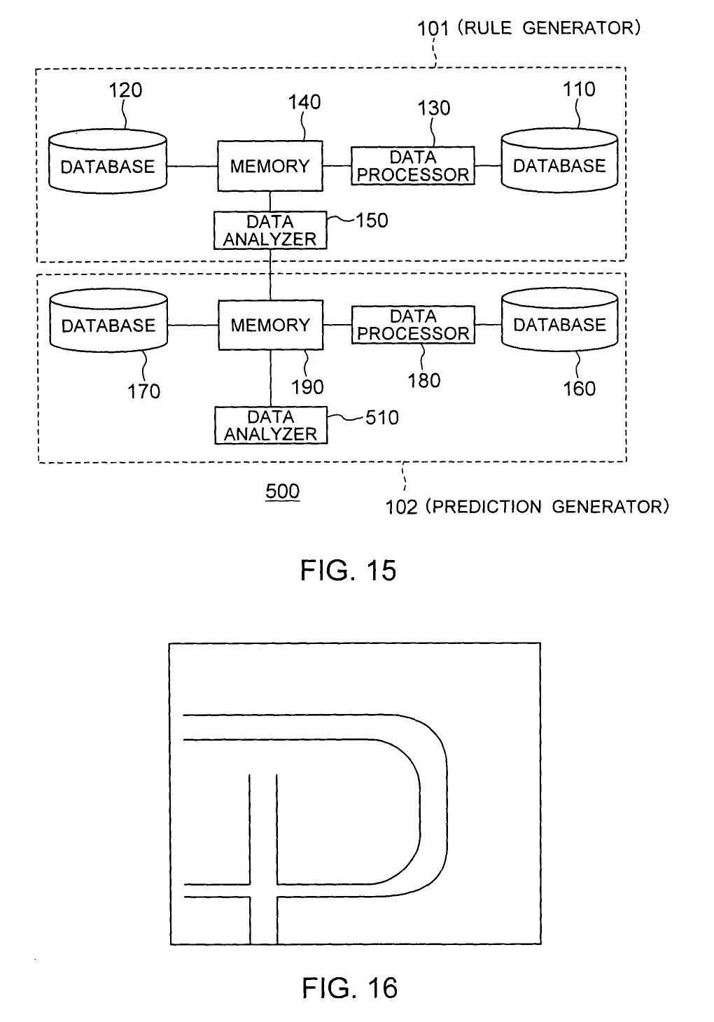

FIG. 15 is a block diagram of a data prediction device 500 according to the fifth embodiment of the invention. The data prediction device 500 includes a rule generator 101 and a prediction generator 102.

The rule generator 101 generates a logical rule for an event to occur from observation data as a result of observation of an event in the first region, attribute data representing geographical features of the observation point and degree data indicating the degree of agreement with the attribute data.

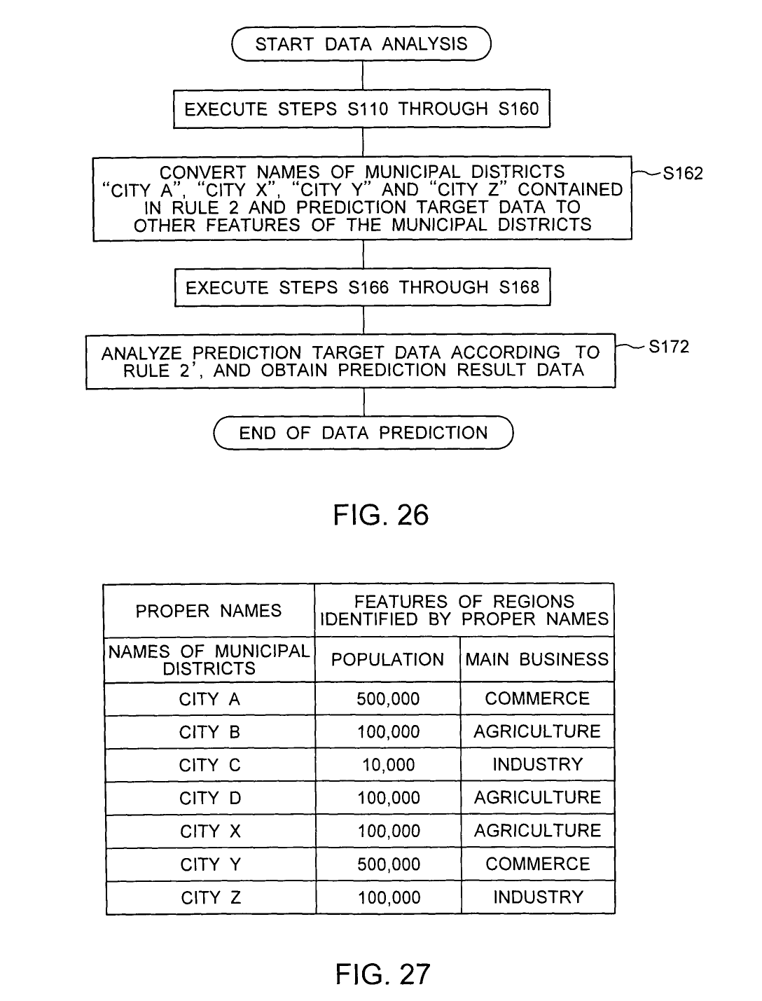

The rule generator 101 has the same configuration as the data analysis device 100 shown in FIG. 15. The rule generator 101, however, may have the same configuration as that of the data analysis device 200 or 300 shown in FIG. 22 or 26.

The prediction generator 102 applies the rule generated by the rule generator 101 to the second region to predict the tendency for the same event to occur in the second region. The attribute data used here are a kind of data representing an arbitrary feature in a certain location within a geographical range. The degree data are a kind of data representing the degree of agreement with the attribute data for individual positional data. The attribute data may be reworded as attribute names. The degree data may be reworded as attribute values exhibiting values of agreement with the attribute names.

The rule generator 101 includes a database 110, database 120, data processor 130, memory 140 and data analyzer 150. The database 110 stores geographical information data of the first region. The database 120 stores analysis target data expressing the observation data as a result of observation of an event having occurred in the first region together with the positional data of the observation points in form of a table.

FIG. 16 is a schematic diagram of an example of geographical information data of a first region. The geographical information data is a kind of data showing a one- or more-dimensional space. Typically, it is data showing a two-dimensional space and a three-dimensional space in a vector form or a graphic form. For example, geographical information data are map data, GIS (geographical information system) data, or the like. FIG. 16 is a schematic diagram of the map data showing roads running in the first region.

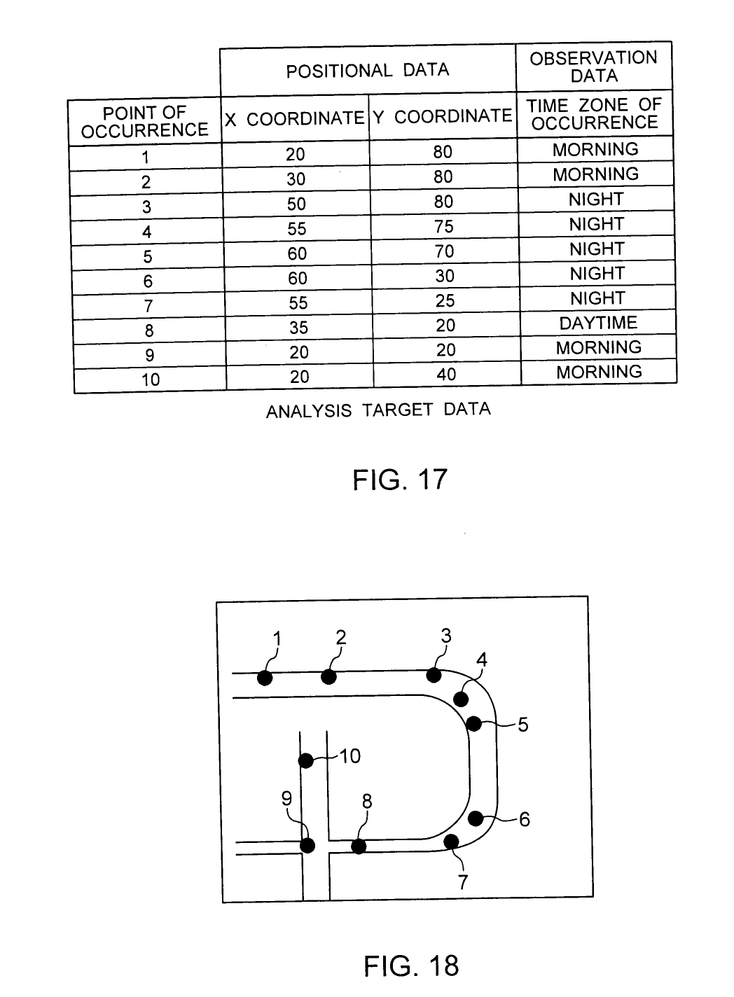

FIG. 17 is a schematic diagram of an example of analysis target data. The observation data are a kind of data as a result of observation of the tendency for an event, such as traffic accidents, to occur in the first region. The positional data exhibit positional coordinates of points where traffic accidents occurred. In the example of FIG. 17, the observation data show time zones where the traffic accidents occurred at points 1 through 10. The positional data show positional coordinates (X, Y) of points 1 through 10. The positional data may be reworded as positional attributes showing positional coordinates in the geographical region.

FIG. 18 is a schematic diagram showing an aspect of positional data shown in FIG. 17 plotted on map data shown in FIG. 16. FIG. 18 shows points 1 through 10 by dark dots.

The data processor 130 searches out geographical features of the first region from the database 110, and converts attribute data representing the features as well as degree data exhibiting degrees of agreement of points 1 through 10 with those features in form of a table. Additionally, the data processor 130 adds the attribute data and the degree data to the analysis target data. Attribute data and degree data in the first region are herein called the first attribute data and the first degree data, respectively.

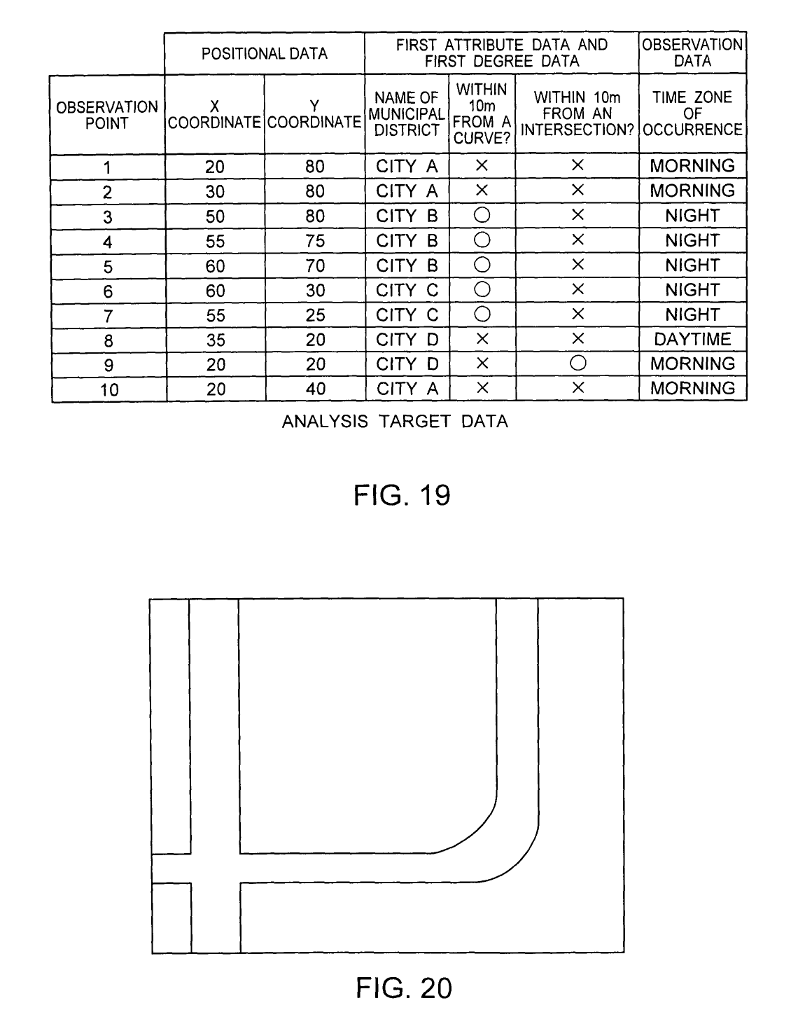

FIG. 19 is a schematic diagram of an example of geographical information data added with the first attribute data and the first degree data. The first attribute data contain three different items, namely, “names of municipal districts such as cities or towns”, “within 10 meters from a curve?” and “within 10 meters from an intersection?”. First degree data corresponding to the item of “names of municipal districts” of the first attribute data are composed of names of municipal districts (city A, city B, city C or city D) where the points 1 through 10 reside. First degree data corresponding to the item of the first attribute data saying “within 10 meters from a curve?”describe whether the individual points 1 through 10 reside within 10 meters from a curve or not (o or x). First attribute data corresponding to the item of the first attribute data saying “within 10 meters from an intersection?”describe whether the individual points 1 through 10 reside within 10 meters from an intersection or not (o or x). The first attribute data and the first degree data are added to the analysis target data.

The memory 140 temporally stores data such as analysis target data.

The data analyzer 150 analyzes analysis target data added with the first attribute data and the first degree data, and derives a logical rule causing traffic accidents. The data analyzer 150 can obtain a logical rule characterizing time zones of traffic accidents by analyzing the data by data mining technique using a decision tree, for example. From the analysis target data shown in FIG. 19, two following logical rules are obtained.

Rule 1: If a point is within 10 meters from a curve, then the time zone of traffic accidents at the point is night.

Rule 2: If the municipal district of a point is city A, then the time zone of traffic accidents at a point is morning.

These logical rules are stored in the memory 190 of the prediction generator 102.

The prediction generator 102 includes a database 160, database 170, data processor 180, memory 190 and data analyzer 510. The database 160 stores geographical information data of the second region different from the first region whose geographical information data is stored in the database 110. The database 170 stores prediction target data that include positional data of the second region but does not include observation data as a result of observation of an event having occurred at the point defined by the positional data.

FIG. 20 is a schematic diagram of an example of geographical information data of a second region. The geographical information data are a kind of data describing one- or more-dimensional space. Typically, it is a data showing a two-dimensional space and a three-dimensional space in a vector form or a graphic form. For example, geographical information data are map data, GIS (geographical information system) data, or the like. FIG. 20 is a schematic diagram of map data showing roads running in the second region.

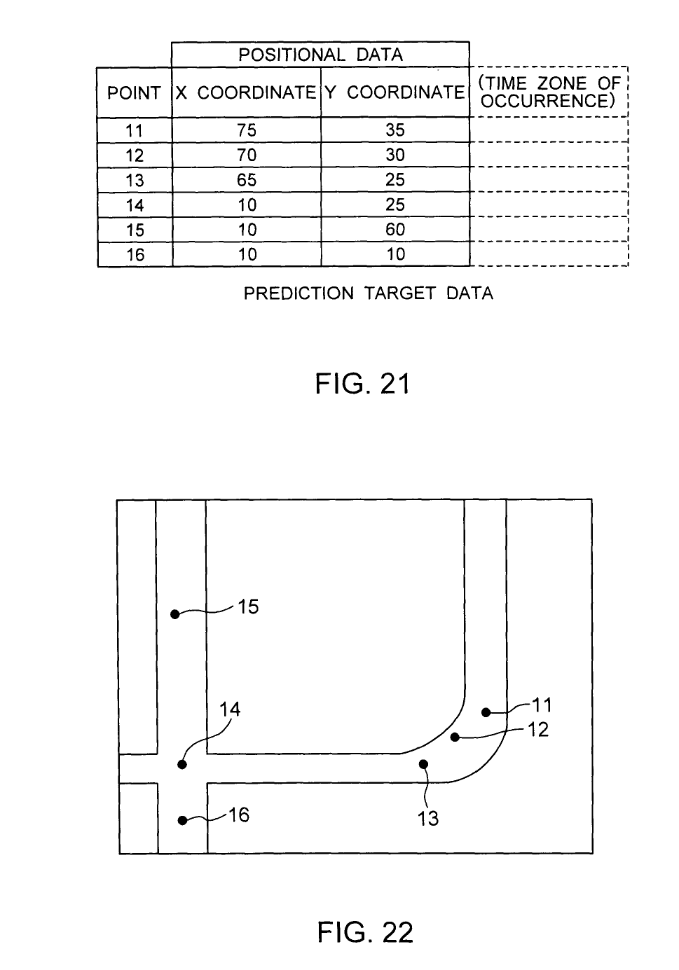

FIG. 21 is a schematic diagram of an example of prediction target data. The prediction target data contain positional coordinates (X, Y) of points 11 through 16 in the second region where traffic accidents occurred. However, the prediction target data do not contain observation data of points 11 through 16. The prediction generator 102 predicts observation data of prediction target data. For easier understanding, predicted observation data are called prediction data.

FIG. 22 is a schematic diagram showing positional data shown in FIG. 21 plotted on map data shown in FIG. 20. FIG. 22 shows points 11 through 16 by dark dots.

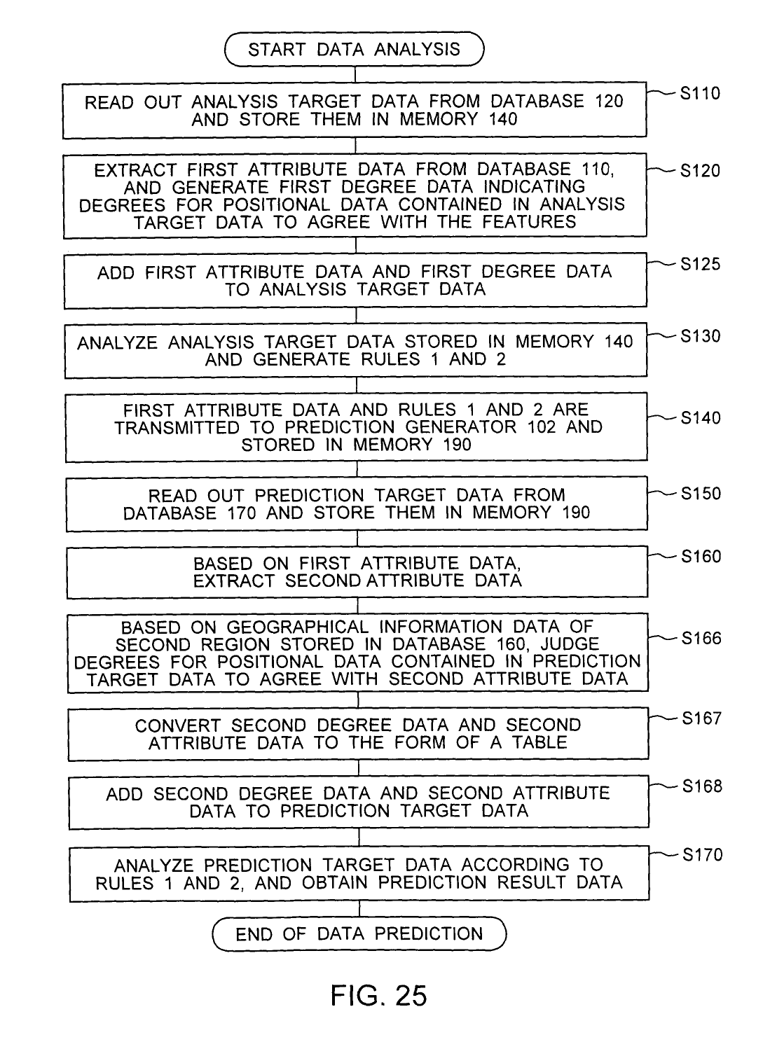

The data processor 180 extracts second attribute data representing geographical features of prediction points in the second region on the basis of the first attribute data used in the analysis target data. The data processor 180 judges degrees of agreement of points 11 through 16 of actual traffic accidents with the second attribute data, and generates second degree data representing these degrees. Furthermore, the data processor 180 converts the second degree data and the second attribute data to the form of a table. A technique for judging degrees of agreement of positional data with the second attribute data will be explained later in conjunction with step S166 of FIG. 25. Furthermore, the data processor 180 adds the second attribute data and the second degree data to the prediction target data.

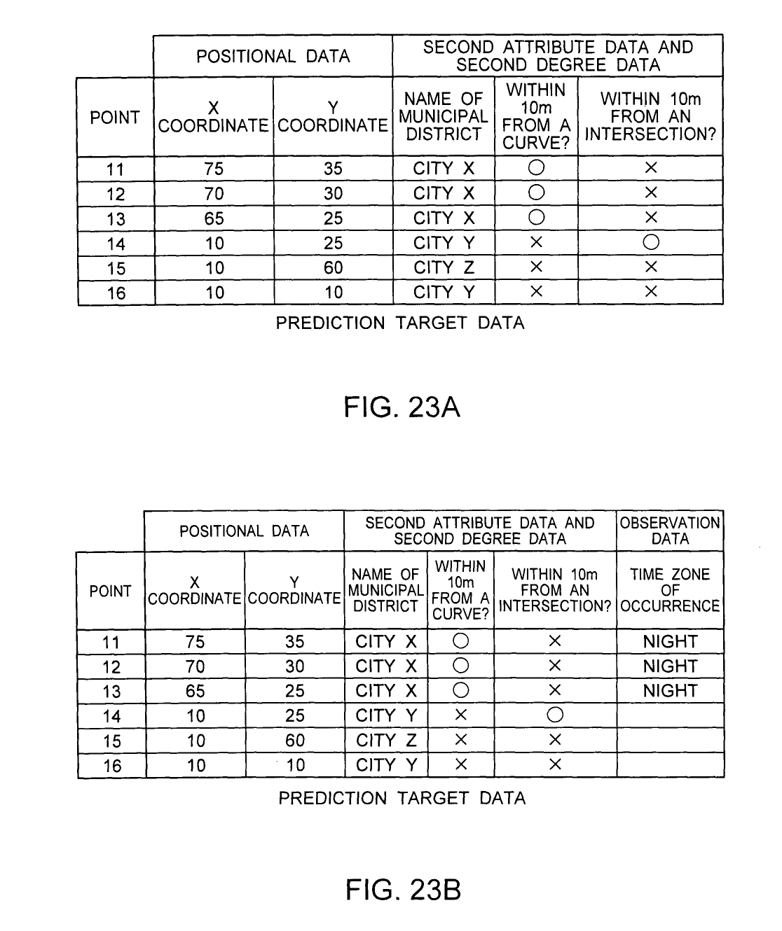

FIG. 23A is a schematic diagram of an example of prediction target data added with attribute data. In this specific example, three different features, namely, “names of municipal districts” the points 11 through 16 belong to, whether the points 11 through 16 are “within 10 meters from a curve or not”, and whether the points 11 through 16 are “within 10 meters from an intersection or not”, are added as second attribute data. The second attribute data shown in FIG. 23A are identical to the first attribute data.

Degree data representing degrees of agreement with the second attribute data are added to the prediction target data. More specifically, in association with the attribute data “names of municipal districts”, degree data saying “city X”, “city Y” or “city Z” are added. In association with the attribute data describing “within 10 meters from a curve, or not” and “within 10 meters from an intersection, or not”, degree data exhibiting “o” or “x” are added, respectively.

The memory 190 temporally stores logical rules from the rule generator 101 and first attribute data, as well as prediction target data, etc. from the database 170.

The data analyzer 510 analyzes the prediction target data added with the second attribute data on the basis of the logical rules stored in the memory 190. Thereby, the data analyzer 510 predicts the tendency for traffic accidents to occur at positions defined by positional data in the second region. In greater detail, the data analyzer 510 applies the above-mentioned rule 1 saying “if a position is within 10 meters from a curve, then the time zone of traffic accidents at the position is night” to the prediction target data shown in FIG. 23A. As a result, the prediction result data as shown in FIG. 23B are obtained.

FIG. 23B is a schematic diagram showing an example of prediction target data having prediction data as a result of application of the rule 1 to the prediction target data shown in FIG. 23A. Since the points 11 through 13 have the feature of being “within 10 meters from a curve”, they satisfies the rule 1. Therefore, here is obtained the prediction data describing that the time zone of traffic accidents at the points 11 through 13 is night. In this manner, the data prediction device 500 according to the instant embodiment generates logical rules based on the observation data of an event having occurred in the first region, and can predict the tendency for the event to occur in the second region by applying the logical rules to the second region.

The data prediction device 500 shown in FIG. 15 includes the rule generator 101 and the prediction generator 102 as separate components. However, since the rule generator 101 and the prediction generator 102 have similar configurations, they may be designed to share common components.

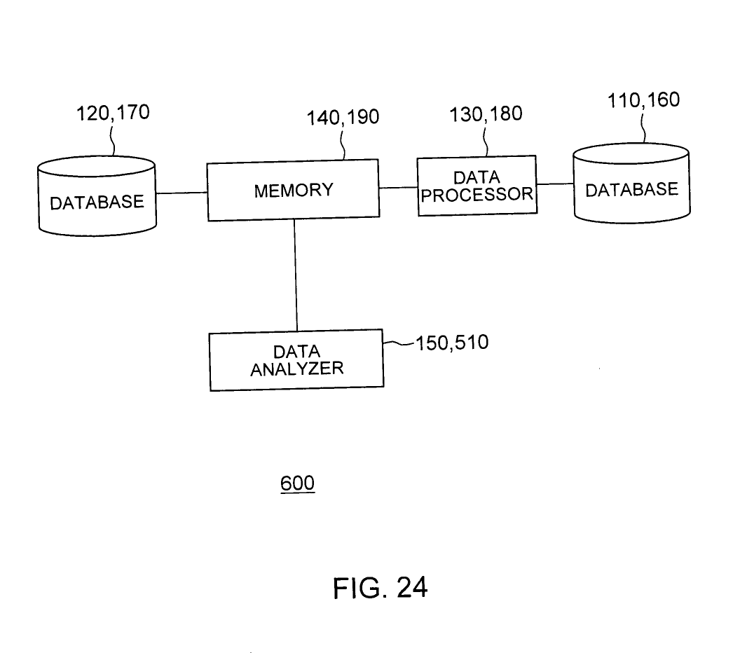

FIG. 24 is a block diagram of a data prediction device 600 using components commonly for both the rule generator 101 and the prediction generator 102. The data prediction device 600 according to this embodiment uses a single database 110, 160 in lieu of the database 110 for the rule generator 101 and the database 160 for the prediction generator 102. Similarly, the data prediction device 600 uses a single database 120, 170 in lieu of the database 120 for the rule generator 101 and the database 170 for the prediction generator 102. The data prediction device 600 uses a single data processor 130, 180 in lieu of the data processor 130 for the rule generator 101 and the data processor 180 for the prediction generator 102. The data prediction device 600 uses a single memory 140, 190 in lieu of the memory 140 for the rule generator 101 and the memory 190 for the prediction generator 102. Further, the data prediction device 600 uses a single data analyzer 150, 510 in lieu of the data analyzer 150 for the rule generator 101 and the data analyzer 510 for the prediction generator 102.

Common use of a single database can be realized by dividing its data storage region. Similarly, common use of a single memory can be realized by dividing its data storage region. Common use of a single data processor can be realized by time division of a single arithmetic operation device such as CPU. Similarly, common use of the data analyzer can be realized by time division of a single arithmetic operation device such as CPU.

It is also possible to use a single database in replacement of both the database 110, 160 and the database 120, 170 and use a single arithmetic operation device as both the data processor and the data analyzer.

FIG. 25 is a flow chart showing the flow of the process according to the fifth embodiment. The flow of the process according to the instant embodiment is explained below with reference to FIGS. 15 through 25.

Analysis target data are read out from the database 120, and stored in the memory 140 (S110). The analysis target data contain positional data and observation data as shown in FIG. 17.

After that, the data processor 130 extracts first attribute data from the database 110, and creates first degree data exhibiting degrees of agreement of positional data contained in the analysis target data with the features (S120).

Subsequently, the first attribute data and the first degree data are added to the analysis target data (S125). The analysis target data having attribute data are shown in FIG. 19. This embodiment employs names of municipal districts to which the observation points 1 through 10 belong, and whether the observation points 1 through 10 are within 10 meters from a curve or not, as attribute data. It is readily known whether the observation points 1 through 10 are within 10 meters from a curve or not with reference to the plot diagram of FIG. 18.

In the next step, the data analyzer 150 analyzes the analysis target data stored in the memory 140 (S130). As a result, the following two logical rules are obtained.

Rule 1: If a point is within 10 meters from a curve, then the time zone of traffic accidents at the point is night.

Rule 2: If the municipal district of a point is city A, then the time zone of traffic accidents at the point is morning.

The first attribute data as well as the rules 1 and 2 are next transmitted to the prediction generator 102, and stored in the memory 190 (S140).

After that, the prediction target data are read out from the database 170, and stored in the memory 190 (S150). The prediction target data contain positional data but do not contain observation data as shown in FIG. 21.

In the next step, the data processors 180 extract second attribute data on the basis of the first attribute data (S160). In this embodiment, attribute data describing the same geographical feature as the attribute data added to the analysis target data are added to prediction target data. More specifically, three different attribute data, namely, “names of municipal districts”, “within 10 meters from a curve or not” and “within 10 meters from an intersection or not”, are extracted.

In the next step, the data processor 180 refers to the geographical information data of the second region stored in the database 160, and judges degrees of agreement of positional data contained in the prediction target data with the second attribute data (S166).

For example, in case of judging whether a point is “within 10 meters from an intersection” in this step, the data processor 180 first calculates the distance between coordinates of the positional data and coordinates of the intersection, and judges whether the calculated distance is within 10 meters or not. If this distance is 10 meters or less, the degree target data may be “o”. If the distance is 10 meters of more, the degree target data may be “x”.

For example, in case of judging “names of municipal districts” in this step, territories of individual municipal districts are first defined in the geographical data of the second region, and thereafter, the data processor 180 judges to which territory each positional data belongs. Then the names of municipal districts to which individual positional data belong to may be used as degree target data.

The data processor 180 next converts the second degree data and the second attribute data to the form of a table (S167).

In the next step, the data processor 180 adds the second degree data and the second attribute data to the prediction target data (S168). FIG. 23A shows such prediction target data in form of a table already added with second degree data and second attribute data. This prediction data, including the second degree data and the second attribute data altogether, are in form of a table.

After that, the data analyzer 510 analyzes the prediction target data according to the rules 1 and 2 (S170). As a result, the prediction result data shown in FIG. 23B is obtained.

According to the instant embodiment, it is possible to predict that “the time zone of traffic accidents at the points 11 through 13 is night” according to the rule 1 saying “if a point is within 10 meters from a curve, then the time zone of traffic accidents at the point is night” because the points 11 through 13 agree with the second attribute data describing “within 10 meters from a curve (that is, they were evaluated as “o”). As to the points 14 through 16, however, no tendency is predictable from the rule 1 because the points 14 through 16 do not agree with the second attribute data saying “within 10 meters from a curve” (that is, they were evaluated as “x”).

In this embodiment, the procedures from that of step S110 to transmission of the rules 1 and 2 of step S140 are executed by the rule generator 101, and the procedures from storage of the rules 1 and 2 of step S140 to the procedure of step S170 are executed by the prediction generator 102.

This embodiment enables prediction of the points 11 through 13 according to the rule 1. That is, the embodiment adds attribute data to prediction target data, and can predict the tendency for an event described by the prediction target data to occur, according to logical rules.

(Sixth Embodiment)

The above-explained fifth embodiment cannot predict any tendency from the rule 2 describing “if the municipal district is city A, the time zone of traffic accidents is morning” because the name of the municipal district “city A” contemplated in the rule 2 and “city X, city Y and city Z” contained in the prediction target data are proper names. Proper names are applicable exclusively to the subjects they identify. That is, they are not applicable to other general regions.

Thus the sixth embodiment enables prediction even when prediction target data contain proper names, by applying logical rules to the prediction target data.

FIG. 26 is a flow chart showing the flow of the process according to the sixth embodiment. Steps S110 through S160 of this embodiment are identical to those of the fifth embodiment.

Next to step S160, the data processor 180 converts the names of municipal districts, “city A” and “city X, city Y, city Z” contained in the rule 2 and the prediction target data to other features of these municipal districts (S162).

FIG. 27 is a schematic diagram showing proper names of municipal districts and features of the municipal districts in form of a table. Here are shown populations and main industries as features of these municipal districts. By combining these two kinds of features, municipal districts can be distinguished from each other. Combinations of features of municipal districts are associated with their names, and stored in the database 160 beforehand.

Second attribute data are converted to “population” and “main industry” of the municipal district. Second degree data indicating “city A” are converted to “commercial city having the population of 500,000”. Second degree data indicating “city X” are converted to “agricultural city having the population of 100,000”. Second degree data indicating “city Y” are converted to “commercial city having the population of 500,000”. Second degree data indicating “city Z” are converted to “commercial city having the population of 100,000”.

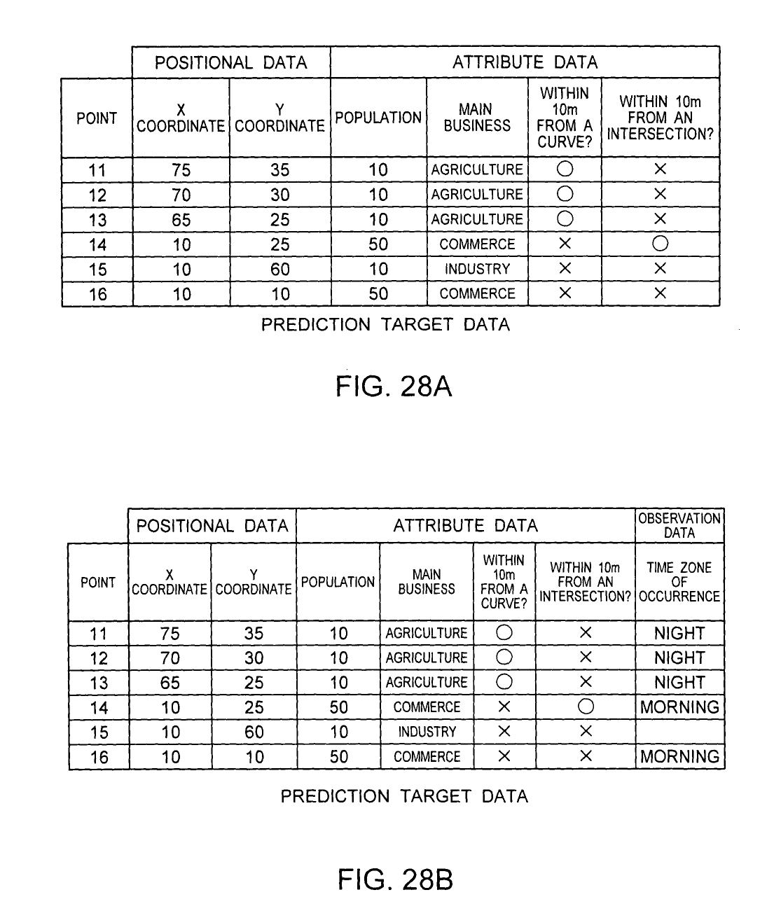

In this manner, by replacement of the name of the municipal district referred to in the rule 2 with the features of the municipal district shown in FIG. 27, the rule 2 can be changed to the rule 2 ′ describing “if a point is in a commercial city having the population of 500,000, then the time zone of traffic accidents is morning.” Additionally, the names of municipal districts in the prediction target data shown in FIG. 23A can be replaced by combinations of features of the municipal districts shown in FIG. 27. Furthermore, steps S167 and S168 of FIG. 25 are carried out. Thereby, the prediction target data shown in FIG. 28A are obtained.

In the next step, the data analyzer 510 analyzes the prediction target data shown in FIG. 28A according to the rule 2 ′ (S172). The prediction target data after the analysis is shown in FIG. 28B. Since the points 14 and 16 belong to a “commercial city having the population of 500,000”, the prediction result data describing “the time zone of traffic accidents at the points 14 and 16 is morning” are obtained.

According to the instant embodiment, a tendency of prediction target data can be obtained by using not only the rule 1 but also the rule 2. That is, even when a logical rule or attribute data include a proper name, the proper name can be generalized by replacing it with another feature or a combination of other features. As a result, the logical rule becomes applicable to prediction target data.

As to the rule 1 , this embodiment predicts the time zone of traffic accidents by the same procedure as the fifth embodiment.

Although this embodiment distinguishes individual municipal districts by using two features, if two features are insufficient for distinguishing municipal districts from each other, three or more features of municipal districts may be used. Their combinations enable distinction of more municipal districts.

(Seventh Embodiment)

The fifth and sixth embodiments have been explained as employing the attribute data identical to the first attribute data employed in the analysis target data (see FIG. 19) also in the prediction target data (see FIGS. 23A) as the second attribute data. However, the fifth and sixth embodiments do not use all of the first attribute data in the prediction target data.

For example, in the fifth and sixth embodiments, no logical rule is generated for the attribute data describing “whether it is within 10 meters from an intersection”. Therefore, this attribute data are not used in the prediction target data. Addition of unnecessary attribute data to the prediction target data invites waste of the capacity of the memory 190.

Therefore, for the purpose of downsizing the prediction target data, the seventh embodiment extracts minimum attribute data as second attribute data.

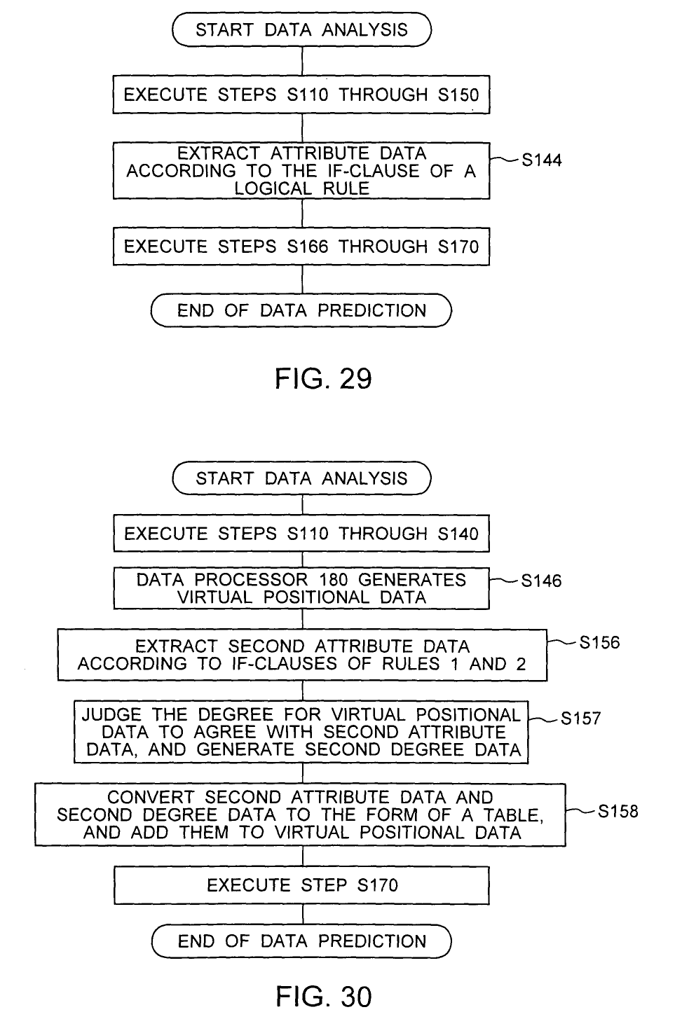

FIG. 29 is a flow chart showing the flow of the process according to the seventh embodiment. In this embodiment, among the attribute data used in the analysis target data, unnecessary attribute data are not added to the prediction target data, and only necessary attribute data are added as second attribute data to the prediction target data. Steps S110 to S150 of this embodiment are identical to the first embodiment shown in FIG. 25.

Subsequently to the step S150, the data processor 180 extracts second attribute data according to the rules 1 and 2 (S144). For example, the rule 1 and the if-clause of the rule 2 are extracted as second attribute data.

Such an if-clause is a part describing a condition (IF part) in an IF-THEN rule such as rule 1 or 2. For example, the if-clause of the rule 1 us “if it is within 10 meters from a curve”, and the if-clause of rule 2 is “if it is city A”. Based on these if-clauses, “whether it is within 10 meters from a curve” and “name of the municipal district” are added as attribute data to the prediction target data. Thereby, unnecessary attribute data saying “whether it is within 10 meters from an intersection” are not added to the prediction target data.

Subsequently, by executing steps S166 to S170 shown in FIG. 25, the same prediction result data as the fifth embodiment can be obtained.

According to this embodiment, since no useless attribute data are added to the prediction target data, the data volume of the prediction target data can be downsized as compared with the fifth and sixth embodiments.

(Eighth Embodiment)

FIG. 30 is a flow chart showing the floor of the process according to the eighth embodiment.

In this embodiment, the data processor 180 generates virtual positional data when no prediction target data having positional data exists, and the prediction target data having the virtual positional data is analyzed. This embodiment is used, for example, when the invention is applied to a road under a plan of future construction.

This embodiment having no prediction target data can omit the database 170 in the data prediction device 500 or 600 shown in FIG. 15 or 24.

Steps S110 through S140 of this embodiment are identical to those of the fifth embodiment.

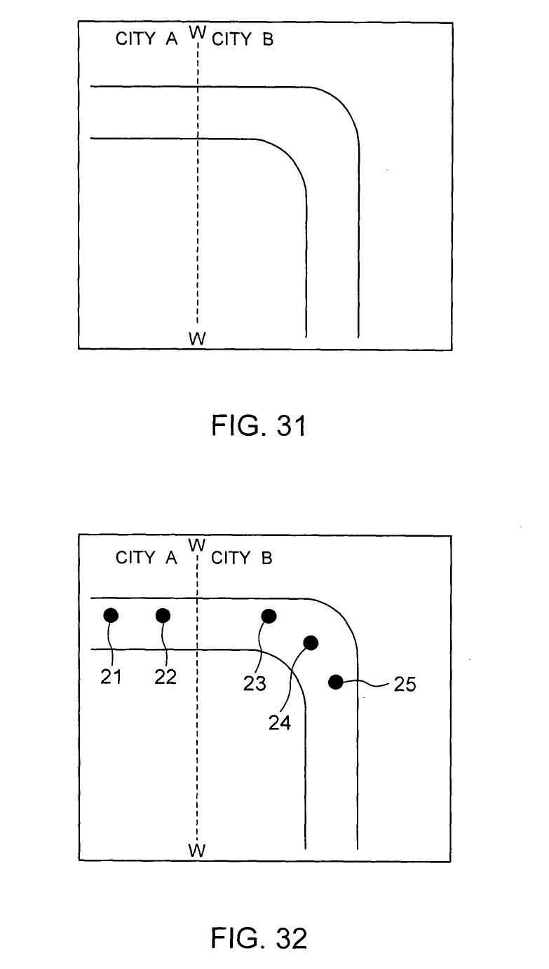

Subsequently to the step S40, the data processor 180 generates virtual positional data (S146). FIG. 31 is a schematic diagram of map data for a road construction plan used in the eighth embodiment. This map data are stored in the database 160.

The broken line W-W in FIG. 31 is the boundary line between city A and city B. City A is in the left side of the broken line W-W, and city B in the right side. The road will be constructed to extend from city A to city B as shown in FIG. 31 according to the plan. That is, the road does not exist yet.

Based on the map data, the data processor 180 generates virtual positional data. FIG. 32 is a diagram of point 21 to point 25 in the virtual positional data plotted on the map data of FIG. 31.

The data processor 180 may arbitrarily generate virtual positional data in the region for the planned road construction. Alternatively, it may generate virtual positional data, leaving a certain distance open.

In the next step, prediction target data are prepared by adding second attribute data and second degree data based on rule 1 and rule 2 to the virtual positional data. In greater detail, based on the if-clauses of rules 1 and 2, “whether it is within 10 meters from a curve” and “names of municipal districts” are extracted as second attribute data (S156). Then the data processor 180 judges whether the virtual positional a within 10 meters from a curve, and judges names of the municipal districts to which the virtual positional data belong. Then the data processor 180 generates second degree data (S157). After that, it converts the second attribute data and the second degree data to the form of a table, and adds it to the virtual positional data of the points 21 through 25 (S158). Thereby, the prediction target data are prepared.

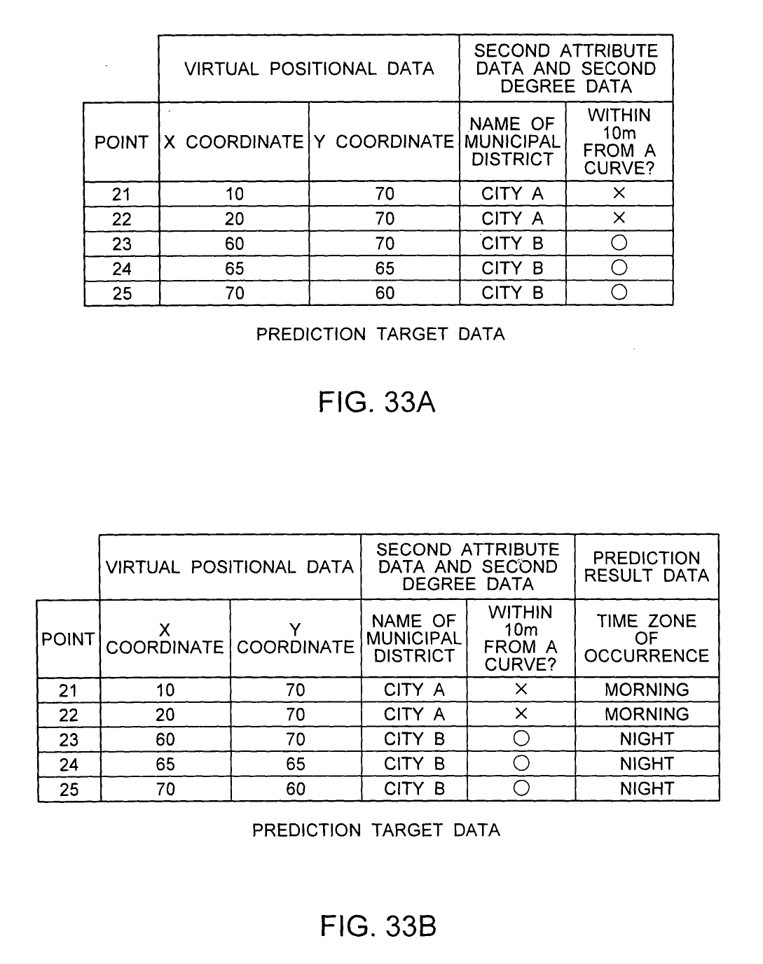

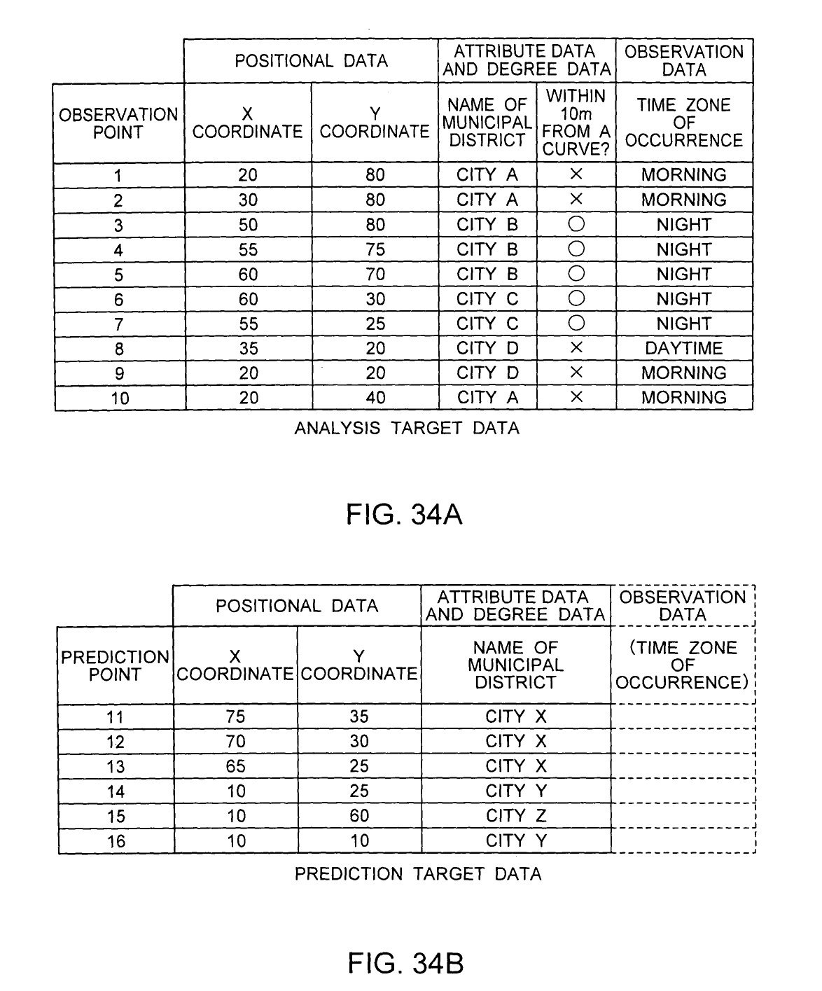

FIG. 33A is a schematic diagram of prediction target data according to the instant embodiment. As shown in FIG. 32, the points 21 and 22 belong to city A, and do not reside within 10 meters from a curve. The points 22 through 25 belong to city B, and reside within 10 meters from a curve. Therefore, attribute data appear as shown in FIG. 33A.

In the next step, by executing the step S170 shown in FIG. 25, the prediction result data shown in FIG. 33B can be obtained. FIG. 33B is a schematic diagram of prediction result data. With reference to the prediction target data shown in FIG. 33B, the time zone for traffic accidents to occur at the points 21, 22 can be predicted to be morning. Additionally, the time zone for traffic accidents to occur at points 23 through 26 can be predicted to be night.

According to the invention, it is possible to predict a tendency of an event like traffic accidents on the basis of virtual geographical information data for a road construction plan.

Although the fifth to eighth embodiments use two logical rules, namely, rule 1 and rule 2. However, only one logical rule or three or more logical rules, may be used as well.

The data analysis methods or data prediction methods explained above may be established either by hardware or by software. In case such a method is established by software, a program for realizing functions of the data prediction device or for realizing the data prediction method may be recorded on a recording medium such as a floppy disk, CD-ROM, or the like, to have a computer read and execute it. The recording medium is not limited to portable ones such as magnetic disks or optical disks, for example, but may be a stationary recording medium such as a hard disk device or memory, as well.

Alternatively, the program for realizing the functions of the data prediction device or the data prediction method may be distributed through communication lines such as Internet (including wireless communication as well). The program may be encoded, modulated or compressed when distributed through wired lines including Internet or through wireless lines, or in storage on a recording medium.

Other embodiments of the present invention will be apparent to those skilled in the art from consideration of the specification and practice of the invention disclosed herein. It is intended that the specification and example embodiments will be considered as examples only, with a true scope and spirit of the invention being indicated by the following.

What is claimed is:

1. A method for preparing data to be analyzed by using a computer including a first memory which stores geographical information data on a geographical region, and a second memory which stores a tabulated form of observation data containing a plurality of positional data indicating locations in the geographical region and event data representing an event having occurred in the locations, comprising:
extracting attribute data representing a certain feature inside the geographical region based on the geographical information data from the first memory;
obtaining degree data indicating the degree of agreement with the attribute data;
converting the attribute data and the degree data to the form of a table; and
preparing data for geographical information analysis by adding the attribute data and the degree data in form of the table to the observation data, the data for geographical information analysis being used to derive a tendency for the event to occur.

2. A data analysis method using a computer including a first memory which stores geographical information data on a geographical region, and a second memory which stores a tabulated form of observation data containing a plurality of positional data indicating locations in the geographical region and event data representing an event having occurred in the locations, comprising:
extracting attributive attribute data representing a certain feature inside the geographical region based on the geographical information data from the first memory;
obtaining degree data indicating the degree of agreement with the attribute data;
converting the attribute data and the degree data to the form of a table;
preparing data for geographical information analysis by adding the attribute data and the degree data in form of the table to the observation data; and
deriving a tendency for the event to occur by using the data for geographical information analysis.

3. A data analysis device comprising:
a first memory storing geographical information data on a geographical region;
a second memory storing tabulated form of observation data containing a plurality of positional data indicating locations in the geographical region and event data representing an event having occurred in the locations;
a data processor extracting attribute data representing a first feature in the geographical region based on the geographical information data, said data processor preparing data for geographical information analysis by converting the attribute data and degree data to the form of a table and then adding the table to the observation data, said degree data indicating the degree of agreement with the attribute data; and
a data analyzer deriving a tendency for the event to occur by using the data for geographical information analysis.

4. A data analysis device according to claim 3, wherein the data processor extracts data representing features on distances from locations defined by the positional data in the geographical region, or data representing features on distribution of a certain condition in the geographical region, as attribute data from the first storage means.

5. A data analysis device according to claim 3, wherein the data processor divides the geographical region into a plurality of regional groups according to the distribution of the positional data, then classifies the observation data into the regional groups on the basis of relationship between the regional groups and the positional data; thereafter adds the regional groups as the attribute data to the observation data; and adds names of the regional groups which the positional data belong to as the degree data to the observation data.

6. A data analysis device according to claim 3, wherein, in case the observation data or the attribute data contain proper data indicating a location on a map in the geographical information data, the data processor finds features on the proper data from information representing geographical features contained in the geographical information data; and converts the proper data to searchable data by using the features or a combination of the features about the proper data, said searchable data being searchable from the first memory.

7. A data analysis device according to claim 6, wherein the proper data is a proper name identifying a certain geographical region.

8. A data analysis device according to claim 3 further comprising:
a third memory storing a second feature and a third feature in relation beforehand; and
a data converter converting expression of the second feature contained in expression of the first feature into expression of the third feature.

9. A data preparation program using a computer including a first memory which stores geographical information data on a geographical region, and a second memory which stores a tabulated form of observation data containing a plurality of positional data indicating locations in the geographical region and event data representing an event having occurred in the locations, to execute:
extracting attribute data representing a certain feature inside the geographical region based on the geographical information data from the first memory;
obtaining degree data indicating the degree of agreement with the attribute data;
converting the attribute data and the degree data to the form of a table; and
preparing data for geographical information analysis used to derive a tendency for the event to occur by adding the attribute data and the degree data in form of the table to the observation data.

10. A data analysis program using a computer including a first memory which stores geographical information data on a geographical region, and a second storage means which stores tabulated form of observation data containing a plurality of positional data indicating locations in the geographical region and event data representing an event having occurred in the locations, to execute:
extracting attribute data representing a first feature inside the geographical region based on the geographical information data from the first memory;
obtaining degree data indicating the degree of agreement with the attribute data;
converting the attribute data and the degree data to the form of a table;
preparing data for geographical information analysis by adding the attribute data and the degree data in form of the table to the observation data, said data for geographical information analysis being used to derive a tendency for the event to occur; and
deriving a tendency for the event to occur by using the data for geographical information analysis.

11. A data analysis program according to claim 10, wherein, during extracting the attribute data, data representing features on distances from locations defined by the positional data in the geographical region, or data representing features on distribution of a certain condition in the geographical region, is extracted as attribute data.

12. A data analysis program according to claim 10, wherein, during extracting the attribute data, the geographical region is divided into a plurality of regional groups according to the distribution of the positional data, and the regional groups are extracted as the attribute data,
wherein the computer further executes classifying the observation data to the regional groups according to the relationship between the regional groups and the positional data after extracting the attribute data,
wherein, during preparing the data for geographical information analysis, the regional groups are added as the attribute data to the observation data, and names of the regional groups, to which the positional data belongs, are added as the degree data to the observation data.

13. A data analysis program according to claim 10 further executing, when the observation data or the attribute data contain proper data indicating a location on a map in the geographical information data, finding features of the proper data from information representing geographical features assigned to the proper data and contained in the geographical information data, and converting the proper data to data applicable to a plurality of locations by using the features of the proper data or a combination of the features of the proper data.

14. A data analysis program according to claim 13, wherein the proper data is a proper name identifying a certain geographical region.

15. A data analysis program according to claim 10, wherein the computer further includes:
a third memory storing a second feature and a third feature obtainable from the geographical information under a certain relationship beforehand,
wherein, in case the expression of the first feature contains an expression representing the second feature, during converting the attribute data and the degree data, the expression of the second feature contained in the attribute data is converted to an expression of a third feature.

16. A computer comprising:
a processor;
a storage accessible from the processor;
memory accessible from the processor;
data stored in the storage; and
a data analysis program stored in the memory and executed by the processor,
wherein the data comprise:
geographical information data on a geographical region; and
observation data in form of a table containing a plurality of positional data defining positions in the geographical region and event data representing an event at the position,
wherein the program comprises:
extracting attribute data representing a first feature inside the geographical region based on the geographical information data from the geographical information data;
obtaining degree data indicating the degree of agreement with the attribute data;
converting the attribute data and the degree data to the form of a table;
preparing data for geographical information analysis by adding the attribute data and the degree data in form of the table to the observation data, said data for geographical information analysis being used to derive a tendency for the event to occur; and
deriving a tendency for the event to occur by using the data for geographical information analysis.

17. A computer according to claim 16, wherein the data further comprise conversion data making a relation between a second feature and a third feature obtainable from the geographical information data, and
wherein the program further comprises, when the expression of the first feature contains an expression of the second feature, converting the expression of the second feature contained in the attribute data to an expression of the third feature with reference to the conversion data.

18. A data prediction method using a computer including a first memory which stores a rule showing relationship between observation data obtained by observing an event in a first region and first attribute data representing geographical features at the observation point of the event; and a second memory which stores geographical information data on a second region different from the first region, comprising:
extracting second attribute data representing a geographical feature of a prediction point of the event in the second region on the basis of the first attribute data;
judging the degree of agreement with the second attribute data at the prediction point according to the geographical information data and generating degree data representing the degree;
converting the degree data and the second attribute data to the form of a table;
adding the degree data and the second attribute data to the tabulated prediction target data, said prediction target data containing no observation data of the event at the prediction point but containing positional data defining the position of the prediction point; and
analyzing the prediction target data containing the degree data and the second attribute data according to the rule, and predicting the tendency for the event to occur at the prediction point.

19. A data prediction method according to claim 18, wherein the computer further includes a rule generator which generates the rule and transmits the rule to the first memory, and
wherein the method further comprises:
prior to extracting the second attribute data, generating the rule by analyzing analysis target data containing the observation data and the first attribute data; and
transmitting the rule to the first memory.

20. A data prediction method according to claim 18, wherein the feature the second attribute data represents is identical to the feature the first attribute data represents.

21. A data prediction method according to claim 18, wherein the feature the second attribute data represents is an if-clause of the rule.

22. A data prediction method according to claim 18 further comprising, prior to analyzing the prediction target data, converting a proper name to a feature of the region or a combination of features of the region, said proper name being associated with the first region contained in the rule or being associated with the second region contained in the prediction target data.

23. A data prediction method according to claim 18, wherein the positional data are virtually generated data.

24. A data prediction device comprising:
a first memory which stores a rule showing relationship between observation data obtained by observing an event in a first region and first attribute data representing geographical features at the observation point of the event;
a second memory storing geographical information data on a second region different from the first region;
a data processor extracting second attribute data representing a geographical feature of a prediction point of the event in the second region on the basis of the first attribute data; generating degree data representing the degree of agreement with the second attribute data at the prediction point according to the geographical information data; converting the degree data and the second attribute data to the form of a table; and adding the second attribute data and the degree data to the tabulated prediction target data, said prediction target data containing positional data defining the position of the prediction point but not containing observation data of the event at the prediction point; and
a data analyzer analyzing the prediction target data containing the second attribute data and the degree data according to the rule, and thereby predicting the tendency for the event to occur at the prediction point.

25. A data prediction device according to claim 24 further including a rule generator generating the rule by analyzing analysis target data containing the observation data and the first attribute data, and transmitting the rule to the first storage means.

26. A data prediction device according to claim 24 further comprising a third memory having the prediction target data in storage beforehand.

27. A data prediction device according to claim 24, wherein the feature the second attribute data represents is identical to the feature the first attribute data represents.

28. A data prediction device according to claim 24, wherein the feature the second attribute data represents is an if-clause of the rule.

29. A data prediction device according to claim 24, wherein, if the rule includes the proper name of the first region or if the prediction target data includes the proper name of the second region, the data processor converts the proper name to a feature of the region or a combination of features of the region.

30. A data prediction device according to claim 24, wherein the positional data are virtually generated data.

31. A data prediction program using a computer including a first memory which stores a rule showing relationship between observation data obtained by observing an event in a first region and first attribute data representing geographical features at the observation point of the event; and a second memory which stores geographical information data on a second region different from the first region, to execute:
extracting second attribute data representing a geographical feature of a prediction point of the event in the second region on the basis of the first attribute data;
judging the degree of agreement with the second attribute data at the prediction point according to the geographical information data and generating degree data representing the degree;
converting the degree data and the second attribute data to the form of a table;
adding the degree data and the second attribute data to the tabulated prediction target data, said prediction target data containing no observation data of the event at the prediction point but containing positional data defining the position of the prediction point; and
analyzing the prediction target data containing the degree data and the second attribute data according to the rule, and predicting the tendency for the event to occur at the prediction point.

32. A computer comprising:
a processor;
a storage accessible from the processor;
memory accessible from the processor;
data stored in the storage; and
a data analysis program stored in the memory and executed by the processor,
wherein the data comprises:
rule data showing relationship between observation data obtained by observing an event in a first region and first attribute data representing geographical features at the observation point of the event;
observation data in form of a table containing a plurality of positional data defining positions in the region and event data representing an event at the position; and
geographical information data of a second region different from the first region,
wherein the program comprises:
extracting second attribute data representing a geographical feature of a prediction point of the event in the second region on the basis of the first attribute data;
judging the degree of agreement with the second attribute data at the prediction point according to the geographical information data and generating degree data representing the degree;
converting the degree data and the second attribute data to the form of a table;
adding the degree data and the second attribute data to the tabulated prediction target data, said prediction target data containing no observation data of the event at the prediction point but containing positional data defining the position of the prediction point; and
analyzing the prediction target data containing the degree data and the second attribute data according to the rule, and predicting the tendency for the event to occur at the prediction point.
